(19) United States
(12) Patent Application Publication
(10) Pub. No.: US 2025/0288913 A1
(43) Pub. Date: Sep. 18, 2025

(54) SHOOTING GAME SYSTEM AND ENTERTAINMENT FACILITY

(71) Applicant: Nintendo Co., Ltd., Kyoto (JP)

(72) Inventors: Yasuyuki SHIMOHATA, Kyoto (JP); Yasuyuki ASADA, Kyoto (JP); Akio IKEDA, Kyoto (JP)

(21) Appl. No.: 19/060,003

(22) Filed: Feb. 21, 2025

(30) Foreign Application Priority Data
Mar. 15, 2024 (JP) 2024-041658

(51) Int. Cl. A63F 13/837; A63F 13/25

(52) U.S. Cl. CPC A63F 13/837; A63F 13/25

(57) ABSTRACT

A non-limiting example shooting game system comprises a game control PC that is communicably connected with a plurality of gun PCs. A shooting device is electrically connected to each of the gun PCs. The shooting game system is applied to an entertainment facility, and a plurality of AR markers are arranged side by side on a floor surface of the entertainment facility between a placement table of the shooting device and a front screen. Each shooting device is provided with an infrared camera module, and the AR marker is imaged by an infrared camera, and a position and a posture of the infrared camera are calculated based on an imaged image. Each of a plurality of players shoots at a target displayed on the front screen using the shooting device. A shooting direction for each player is calculated based on the posture of each infrared camera at a time of shooting, and an intersection point on the front screen by the shooting device is calculated for each player.

### CROSS REFERENCE OF RELATED APPLICATION

This application claims a priority to Japanese Patent Application No. 2024-041658 filed on Mar. 15, 2024, and the entire content of which is incorporated herein by reference.

### FIELD

This application describes a shooting game system and an entertainment facility, in which each of a plurality of players shoots at a target displayed on a screen by a gun type controller.

### BACKGROUND AND SUMMARY

In a conventional gun game system, an electronic camera that is arranged below a display images a double-circle marker that is projected by a gun controller, and by obtaining a position of the double-circle marker in a camera coordinate system, a coordinates position and a direction on the display to which the gun controller is turned can be obtained through calculation processing with an image processing apparatus.

However, it was not assumed that a plurality of payers perform a shooting game in such a conventional gun game system simultaneously, and if a plurality of payers perform the shooting game simultaneously, it is difficult to distinguish which player shot because of a technique that only the coordinates position etc. to which the gun controller is turned based on an imaged image of the double-circle marker are calculated.

This application discloses a novel shooting game system and entertainment facility.

Moreover, this application discloses a shooting game system and entertainment facility, in which it is possible to correctly distinguish shooting by each of a plurality of players.

A first embodiment is a shooting game system, comprising a screen that is provided upright on a floor surface to be displayed with an image; a plurality of markers that are arranged side by side on the floor surface; a plurality of shooting devices each provided with a camera that images the marker, the camera being set in a direction different from a shooting direction of the shooting device; and one or more processors, wherein the one or more processors calculates, for each of the plurality of shooting devices and based on an image of the marker that is imaged by the camera, coordinates in a virtual space corresponding to an intersection point between the shooting direction of the shooting device corresponding to a position and a direction of the camera and the screen, and makes the shooting game be executed using operation inputs of respective shooting devices and the coordinates of the virtual space.

According to the first embodiment, since the intersection point on the screen that is pointed by each of the shooting devices is calculated based on the image that the markers arranged on the floor surface are imaged, it is possible to distinguish what places or points the plurality of players are shooting on the screen. Therefore, even if the plurality of players play the shooting game simultaneously, the shooting of each of the players is correctly distinguishable.

A second embodiment is the shooting game system according to the first embodiment, further comprising a setting place that the shooting device is set, wherein the plurality of markers are located between the screen and the setting place.

A third embodiment is the shooting game system according to the first embodiment, wherein the shooting device comprises a barrel portion, and the camera is arranged inside a tip end of the barrel portion, facing diagonally downward from the shooting device.

According to the third embodiment, since the camera is arranged inside the tip end of the barrel portion, it is possible to play the shooting game without being aware of the position of the camera.

A fourth embodiment is the shooting game system according to the third embodiment, wherein the barrel portion has a shape that an upper side is projected ahead compared with a lower side, in the tip end of the barrel portion.

According to the fourth embodiment, since the barrel portion has a shape that the upper side is projected ahead compared with the lower side, a gun muzzle becomes difficult to serve as an obstruction to the camera, and therefore, it is possible to make the camera detect the marker on the floor surface easy.

A fifth embodiment is the shooting game system according to the first embodiment, further comprising a plurality of light emitting devices that are arranged above the markers and emit light toward the markers, wherein the markers reflect the light emitted from the light emitting devices.

According to the fifth embodiment, since the light emitting devices are arranged above the markers, it is possible to correctly detect the markers even at a distance as compared with a case where a light emitting device is attached to the shooting device, for example. Therefore, even if the plurality of players play the shooting game side by side, it is possible to correctly detect the markers.

A sixth embodiment is the shooting game system according to the first embodiment, wherein the one or more processors selectively sets, based on an image that is imaged by the camera, a shooting device selectin mode that allows the player to select one shooting device from a plurality of types of shooting devices that the cameras are being activated and a shooting game mode that allows the player to perform the shooting game in a state where the camera of a selected shooting device is being activated, and lowers a frame rate of the camera in the shooting device selection mode than a frame rate of the camera in the shooting game mode.

Since it is necessary to operate the plurality types of shooting devices in the shooting device selection mode, a processing load becomes high if the plurality of players select a shooting device; however, according to the sixth embodiment, it is possible to reduce the processing load while preventing a degradation of a game experience by lowering the frame rate of the camera at the time of the shooting device selection mode than the frame rate of the camera at the time of the shooting game mode.

A seventh embodiment is the shooting game system according to the sixth embodiment, wherein after an end of the shooting game mode, the one or more processors sets, based on the image that is imaged by the camera, a shooting device return mode that it is determined whether the shooting device is placed to a predetermined position in a state where the camera of the selected shooting device is being activated, and lowers a frame rate of the camera at a time of the shooting device return mode than the frame rate of the camera at a time of the shooting game mode.

According to the seventh embodiment, it is possible to reduce the processing load by lowering the frame rate of the camera at the time of the shooting device return mode than the frame rate of the camera at the time of the shooting game mode.

An eighth embodiment is the shooting game system according to the sixth embodiment, wherein the one or more processors displays on the screen, based on an image of the markers that is imaged by the camera, an image that allows the player to select one shooting device when the plurality of shooting devices are turned to the screen in the shooting device selection mode.

According to the eighth embodiment, since information of the camera and the marker are used when selecting one shooting device from the plurality types of shooting devices, it is not necessary to provide a further mechanism or system therefor, and therefore, it is possible to perform the shooting game simply.

A ninth embodiment is the shooting game system according to the fifth embodiment, wherein the light emitted from the light emitting device is an infrared light, and the marker includes a plate-like substrate that is arranged on the floor surface and reflects the infrared light, a first layer that is formed on the substrate and transmits the infrared light, a second layer that is formed on the substrate to be adjacent to the first layer and absorbs the infrared light, and a third layer that is formed on the first layer and the second layer and transmits the infrared light.

A tenth embodiment is the shooting game system according to the ninth embodiment, wherein the first layer and the second layer of the marker are formed same or almost same height.

An eleventh embodiment is the shooting game system according to the first embodiment, further comprising a projector that projects an image on the screen, and the screen is arranged in a curved shape in a longitudinal direction.

According to the eleventh embodiment, since the markers are provided on the floor surface, even if the screen has the curved shape, it does not affect marker detection, and such a curved shape makes the plurality of players lined side by side easily see up to an edge of the screen.

A twelfth embodiment is an entertainment facility that provided with the shooting game system according to the first embodiment.

In also the twelfth embodiment, similar to the first embodiment, the shooting of each of the plurality of players is correctly distinguishable.

The features, aspects and advantages of the embodiment(s) will become more apparent from the following detailed description when taken in conjunction with the accompanying drawings.

### BRIEF DESCRIPTION OF THE DRAWINGS

FIG. 1 is a view showing non-limiting example structure of a shooting game system according to a first embodiment.

FIG. 2 is a block diagram showing non-limiting example electric structure of a game control PC shown in FIG. 1.

FIG. 3 is a block diagram showing non-limiting example electric structure of a gun PC and a shooting device shown in FIG. 1.

FIG. 4 is a view showing a non-limiting example entertainment facility to which the shooting game system shown in FIG. 1 is applied, viewed from the above.

FIG. 5 is a view showing a non-limiting example front screen provided in the entertainment facility shown in FIG. 4, viewed from the front.

FIG. 6A is a view showing a non-limiting example panel printed with an AR marker, FIG. 6B is a view showing non-limiting example structure of the panel shown in FIG. 6A, and FIG. 6C is a view showing a non-limiting example AR marker board.

FIG. 7 is a view showing a non-limiting example booth provided in the entertainment facility and a non-limiting example manner that the player performs shooting.

FIG. 8A is a view showing a non-limiting example appearance of a gun type shooting device, and FIG. 8B is a view showing a non-limiting example appearance of a bazooka type shooting device.

FIG. 9A is a view showing a non-limiting example coordinate system of an infrared camera provided in the shooting device, and FIG. 9B is a view showing non-limiting example AR marker information acquired from an imaged image.

FIG. 10 is a view showing a non-limiting example selection screen for selecting and determining a shooting device to be used in the shooting game.

FIG. 11A is a view showing a non-limiting example front game screen, and FIG. 11B is a view showing a non-limiting example ceiling game screen.

FIG. 12 is a view showing a non-limiting example memory map of a RAM of the game control PC shown in FIG. 2.

FIG. 13 is a view showing a non-limiting example memory map of a RAM of an image processing PC shown in FIG. 3.

FIG. 14 is a flowchart showing non-limiting example overall processing of a game program executed by a processor incorporated in the game control PC shown in FIG. 2.

FIG. 15 is a flowchart showing non-limiting example shooting device selection and determination processing to be executed by the processor incorporated in the game control PC shown in FIG. 2.

FIG. 16 is a flowchart showing non-limiting example intersection point calculation and input processing to be executed by a processor incorporated in the image processing PC shown in FIG. 3.

FIG. 17A is a view showing a non-limiting first example selection screen of a second embodiment, and FIG. 17B is a view showing a non-limiting second example selection screen of the second embodiment.

FIG. 18A is a view showing a non-limiting third example selection screen of the second embodiment, and FIG. 18B is a view showing a non-limiting fourth example selection screen of the second embodiment.

FIG. 19 is a flowchart showing a first part of non-limiting example shooting device selection and determination processing to be executed by the processor incorporated in the game control PC of the second embodiment.

FIG. 20 is a flowchart showing a second part of the non-limiting shooting device selection and determination processing to be executed by the processor incorporated in the game control PC of the second embodiment, following FIG. 19.

FIG. 21 is a flowchart showing a third part of the non-limiting example shooting device selection and determination processing to be executed by the processor incorporated in the game control PC of the second embodiment, following FIG. 19 and FIG. 20.

FIG. 22A is a view showing non-limiting example schematic structure of a gun type shooting device and a storage base thereof, FIG. 22B is a view showing a non-limiting example color of a slope of a groove formed in a support portion that supports a part of the gun type shooting device including a tip end thereof, and FIG. 22C is a view showing non-limiting example schematic structure of a bazooka type shooting device and a storage base thereof.

FIG. 23 is a flowchart showing non-limiting example return processing to be executed by the processor incorporated in the game control PC of a third embodiment.

### DETAILED DESCRIPTION OF NON-LIMITING EXAMPLE EMBODIMENTS

### First Embodiment

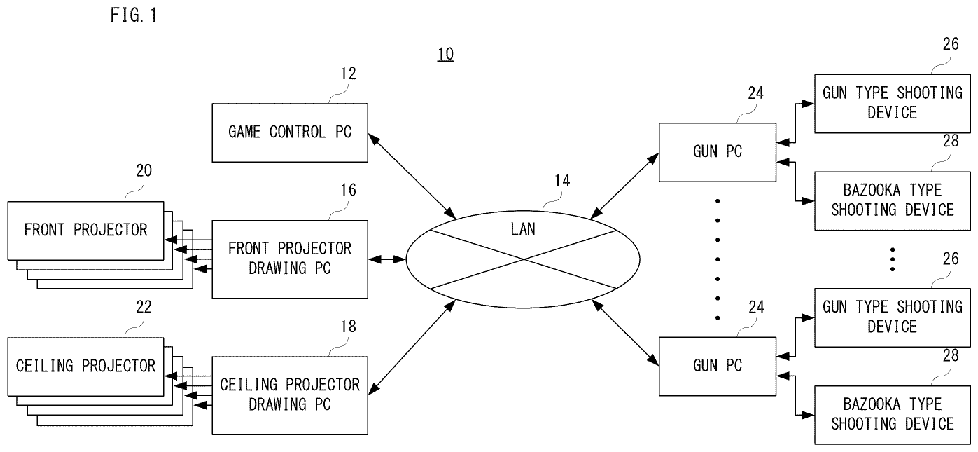

With reference to FIG. 1, a non-limiting example shooting game system 10 is installed in an entertainment facility, and includes a game control PC 12. The game control PC 12 is connected communicably via LAN 14 to a front projector drawing PC 16 and a ceiling projector drawing PC 18. The front projector drawing PC 16 is connected with a plurality of front projectors 20, and the ceiling projector drawing PC 18 is connected with a plurality of ceiling projectors 22.

Moreover, the game control PC 12 is connected communicably to a plurality of gun PCs 24 via the LAN 14. Each of the gun PCs 24 is connected with a gun type shooting device (or gun type controller) 26 and a bazooka type shooting device (or bazooka type controller) 28.

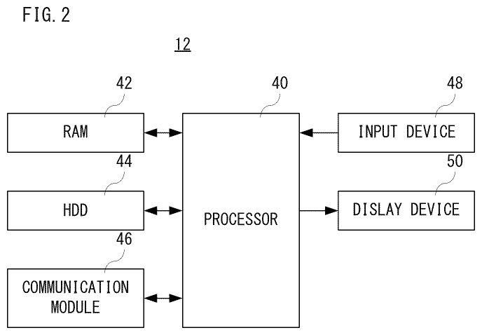

The game control PC 12 is an example of an information processing apparatus, and a PC can be used therefor. However, a server may be used instead of the PC. FIG. 2 is a non-limiting example block diagram showing electric structure of the game control PC 12. As shown in FIG. 2, the game control PC 12 includes a processor 40 that is connected with a RAM 42, an HDD 44, a communication module 46, an input device 48 and a display device 50.

The processor 40 is in charge of overall control of the game control PC 12. As an example, the processor 40 is SoC (System-on-a-chip) that incorporates therein a plurality of functions such as a CPU function, a GPU function, a VRAM (Video Random Access Memory), etc.

The RAM 42 is a volatile storage medium and is used as a working memory and a buffer memory for the processor 40. The HDD (Hard Disk Drive) 44 24 is a non-volatile storage medium, and is used to store various information processing programs such as a game program of the first embodiment, to save various kinds of data, and so on. As an example, the game program is a game program of a virtual game such as a shooting game in which a plurality of players shoot at a target object displayed on a game screen, using a shooting device. However, a single player may also play a shooting game.

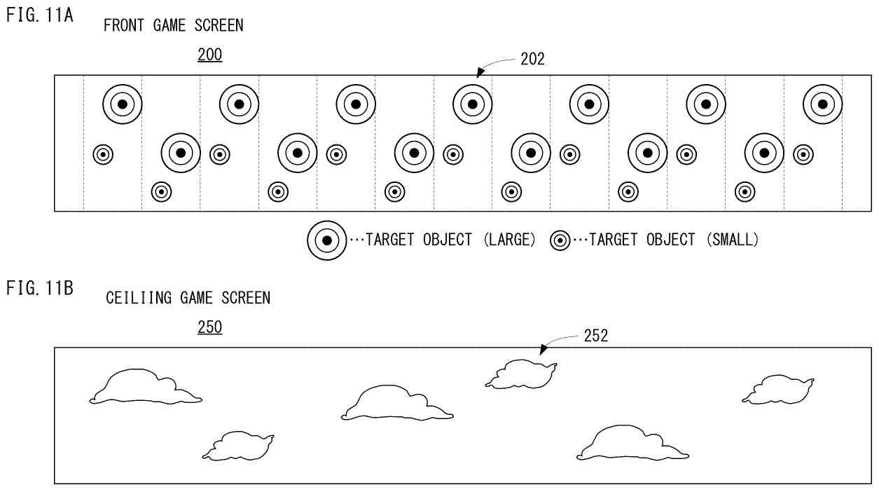

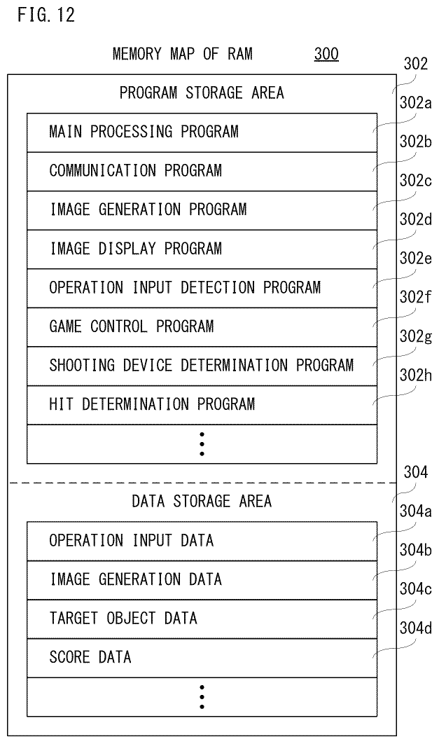

For example, the game program and necessary data are read from the HDD 44 to be stored in the RAM (Random Access Memory) 42. Moreover, during execution of the game program, the GPU incorporated in the processor 40 generates, using image generation data 304b (see FIG. 12) stored in the RAM 42, image data in the VRAM for displaying a game screen (see FIG. 11A) to be displayed in front of the players, generates image data in the VRAM for displaying a game screen (see FIG. 11B) to be displayed above the players, and outputs generated image data to the front projector drawing PC 16 and the ceiling projector drawing PC 18, respectively. However, the game screen that is displayed above the players is a game screen that is displayed on a ceiling to be continued the game screen displayed in the front. Hereinafter, the game screen that displays the game image in front of the players may be referred to as “front game screen”, and the game screen that displays the game image above the players, i.e., on the ceiling may be referred to as “ceiling game screen”.

In addition, the GPU incorporated in the processor 40 generates in the VRAM, during execution of information processing programs regarding an application other than the virtual game, image data for displaying various screens regarding the application being executed on the display device 50 using image generation data 304b etc. stored in the RAM 42, and outputs the generated image data to the display device 50. Since the application other than the virtual game is not essentials of the present invention, in the following, descriptions thereof will be omitted.

The communication module 46 has a function to access a wired LAN. Therefore, the processor 40 transmits or receives data to or from other apparatuses via the LAN 14 using the communication module 46, for example. In the first embodiment, it is assumed that other apparatuses may be the front projector drawing PC 16, the ceiling projector drawing PC 18 and respective gun PCs 24. Moreover, the communication module 46 may have a function to access a wireless LAN with a system conformed to the standard of IEEE802.11.b/g, for example. In such a case, it is possible to perform directly transmission and reception of data with other apparatuses using the communication module 46.

The input device 48 includes a key board and a computer mouse, and may be further provided with a touch panel, etc. The display device 50 is a display such as an LCD or an organic EL.

In addition, the electric structure of the game control PC 12 shown in FIG. 2 is a mere example, and does not need to be limited to this. For example, the game control PC 12 may be constituted in a manner that an external memory such as an optical memory disk, a USB memory or a memory card is attachable and detachable. Moreover, an SSD (Solid State Drive) may be provided instead of the HDD 44.

The front projector drawing PC 16 and the ceiling projector drawing PC 18 are general-purpose PCs, respectively. However, instead of the PC, a server may be used. Although a detailed description is omitted, the front projector drawing PC 16 and ceiling projector drawing PC 18 each has the same or similar electric structure as those of the game control PC 12 shown in FIG. 2.

The front projector 20 and the ceiling projector 22 are projectors that display an image, respectively. A screen such as a front game screen is displayed on a screen that is provided upright (vertically) on a floor surface (hereinafter, may be referred to as “front screen”) Sc by a plurality of front projectors 20. However, as the front screen Sc, a wall mounted screen or a freestanding screen may be used. Moreover, it is possible to use a wall itself as the front screen Sc. Moreover, a screen such as a ceiling game screen is displayed on a ceiling by a plurality of ceiling projectors 22. However, by providing a screen on the ceiling, it is possible to display a screen such as a ceiling game screen on the screen.

The front projector drawing PC 16 divides screen data transmitted from the game control PC 12 into a plurality pieces of screen data and outputs the divided screen data to each of the plurality of front projectors 20 so that the front game screen is displayed for each frame by the plurality of front projectors 20 while forming overlapping areas of adjacent front game screens. However, the frame is a unit time for updating the screen.

The ceiling projector drawing PC 18 divides screen data transmitted from the game control PC 12 into a plurality pieces of screen data and outputs the divided screen data to each of the plurality of ceiling projectors 22 so that the ceiling game screen is displayed for each frame by the plurality of ceiling projectors 22 while forming overlapping areas of adjacent ceiling game screens.

As described above, the gun type shooting device 26 and the bazooka type shooting device 28 are connected to the gun PC 24. In this specification, when there is no necessity of distinguishing the gun type shooting device 26 and the bazooka type shooting device 28, a term “shooting device” is simply used.

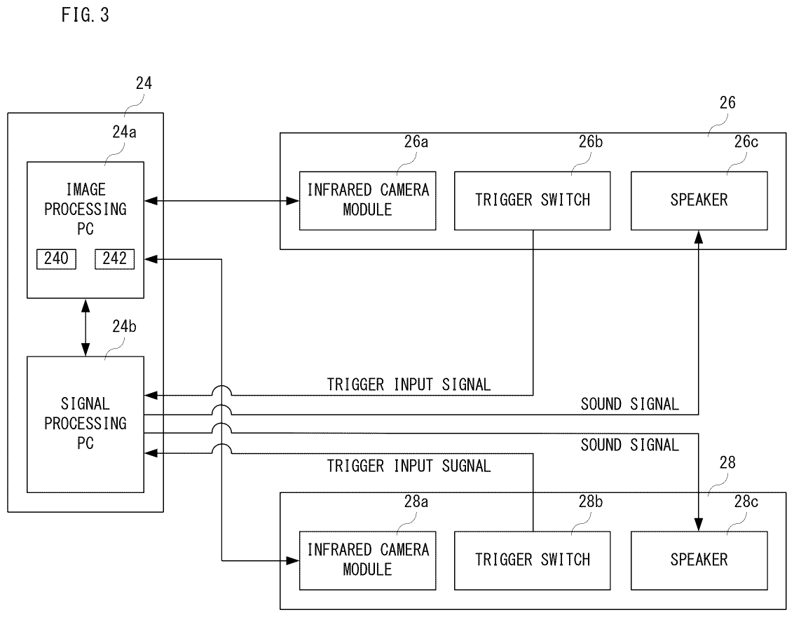

FIG. 3 is a block diagram showing electric structure of the gun PC 24 and two shooting devices (26, 28).

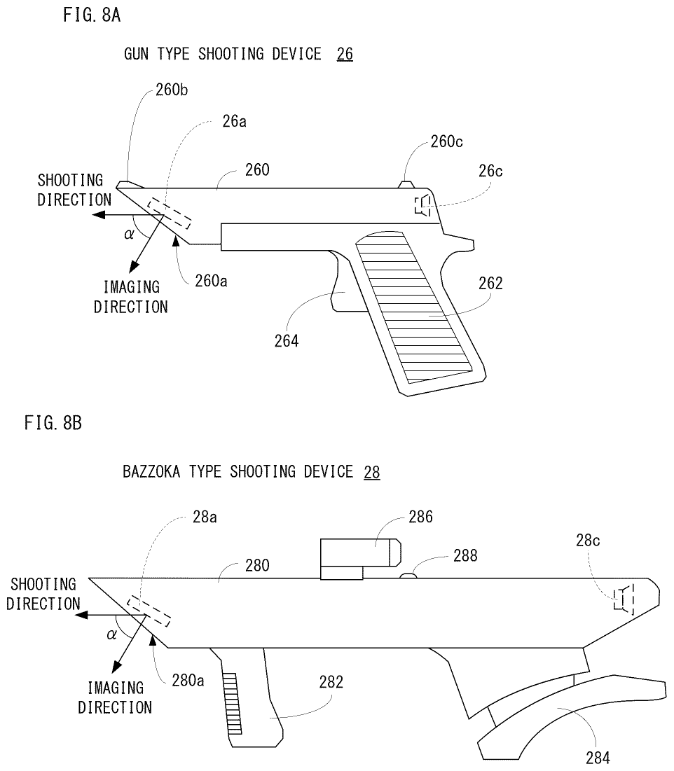

As shown in FIG. 3, the gun PC 24 includes an image processing PC 24a and a signal processing PC 24b, and the image processing PC 24a and the signal processing PC 24b are communicably connected with each other using a LAN cable. Moreover, the image processing PC 24a is communicably connected to the game control PC 12 via the LAN 14. The gun type shooting device 26 includes an infrared camera module 26a, a trigger switch 26b and a speaker 26c. Similarly, the bazooka type shooting device 28 includes an infrared camera module 28a, a trigger switch 28b and a speaker 28c. Although the gun type shooting device 26 and the bazooka type shooting device 28 are different from each other in appearance structure thereof (see FIG. 8A and FIG. 8B), are the same in function.

The image processing PC 24a is electrically connected with the infrared camera module 26a and the infrared camera module 28a using a USB cable, respectively. The signal processing PC 24b is electrically connected with the trigger switch 26b and the trigger switch 28b using a signal line, respectively, and electrically connected with a speaker 26c and a speaker 28c with using a speaker cable or a USB cable, respectively.

Each of the image processing PC 24a and the signal processing PC 24b is a PC. However, instead of the PC, a server may be used. Although a detailed description is omitted, the image processing PC 24a and the signal processing PC 24b each has the same or similar electric structure as those of the game control PC 12 shown in FIG. 2. Therefore, the image processing PC 24a includes components such as a processor 240 and a RAM 242, and the signal processing PC 24b also includes components such as a processor and a RAM.

The image processing PC 24a activates or stops the infrared camera(s) that constitutes the infrared camera module 26a and/or the infrared camera module 28a according to instructions by the game control PC 12, and receives imaged image data transmitted from the infrared camera module 26a or the infrared camera module 28a. When activated, the infrared camera performs imaging processing for each frame, and transmits the imaged image data to the image processing PC 24a to which the infrared camera module 26a or the infrared camera module 28a having this infrared camera is connected. As described later, the image processing PC 24a calculates, based on the imaged image data, a position on the front screen Sc that the gun type shooting device 26 or the bazooka type shooting device 28 points, i.e., an intersection point. At this time, the intersection point is an impact point when the player is performing the shooting using the gun type shooting device 26 or the bazooka type shooting device 28.

The signal processing PC 24b detects a trigger input signal that is transmitted from the trigger switch 26b or the trigger switch 28b (hereinafter, referred to as “trigger data”), and inputs the detected trigger data to the game control PC 12 via the image processing PC 24a. Moreover, the signal processing PC 24b receives a sound signal from the game control PC 12 via the image processing PC 24a, and outputs the sound signal to the speaker 26c or the speaker 28c. However, the sound signal is a sound signal regarding a sound generated when shot by the shooting device, i.e., a shooting sound in the shooting game.

In addition, although the gun PC 24 is constituted with the image processing PC 24a and the signal processing PC 24b, the gun PC 24 may be a single PC when using a computer having high processing performance.

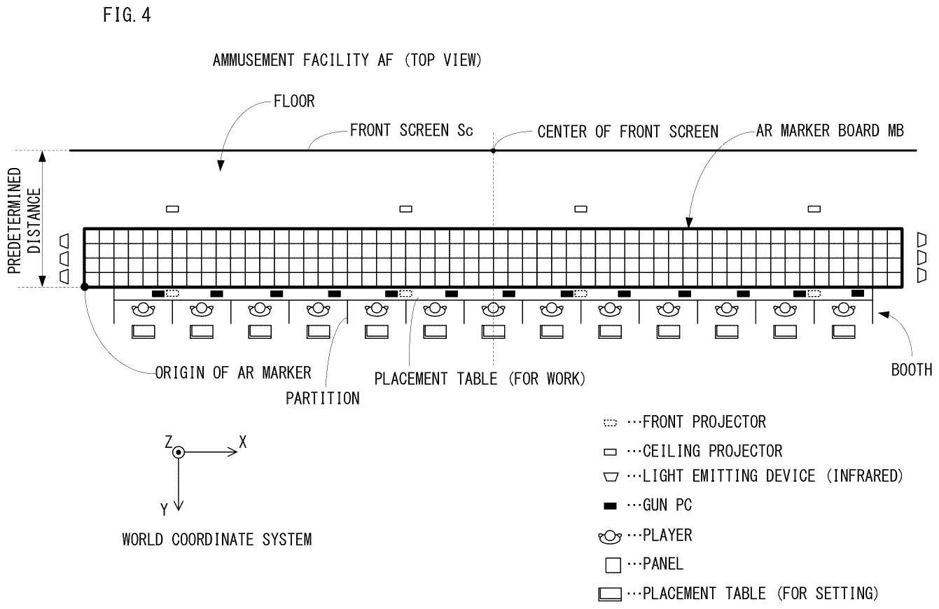

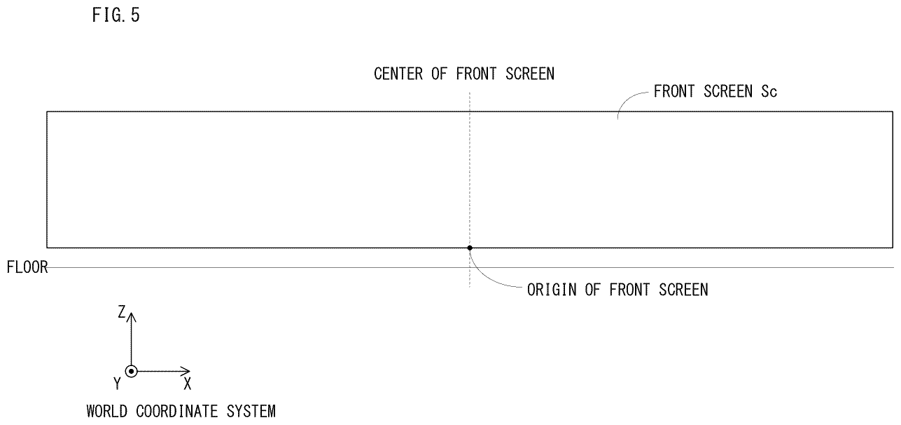

FIG. 4 is a top view showing a non-limiting example entertainment facility AF to which the shooting game system shown in FIG. 1 is applied, viewed from the above. FIG. 5 is a view showing a non-limiting example front screen Sc provided in the entertainment facility AF, viewed from the front.

As shown in FIG. 4, a plurality of booths that are divided with partitions are provided side by side on a straight line, and the player that plays the shooting game is assigned to each booth. However, it is not necessary to assign the players to all the booths, the player(s) may be assigned to some booths only.

Moreover, as shown in FIG. 4, the front screen Sc is arranged in a place separated from the plurality of booths by a predetermined distance. As described above, the front screen Sc is provided upright on the floor surface. The front screen Sc is of a shape of horizontally long plate or belt having a width longer than a width of all the plurality of booths. Moreover, as shown in FIG. 5, the front screen Sc is provided so that a lower end or lower side becomes a position slightly above the floor surface. However, the lower end or the lower side of the front screen Sc may contact the floor surface.

As shown in FIG. 4 and FIG. 5, a world coordinate system corresponding to a room of the entertainment facility AF is set in a virtual space in the game. An X-axis is set respect to a longitudinal direction (or horizontal direction) of the front screen Sc, a Z-axis is set respect to a vertical direction of the room of the entertainment facility AF, and a Y-axis is set respect to a direction perpendicular to both the X-axis and the Z-axis. Moreover, in the room of the entertainment facility AF, an upper direction is set as a positive direction of the Z-axis, a direction toward the plurality of booths from the front screen Sc is set as a positive direction of the Y-axis, and a direction to the right when looking at the front screen Sc from the booths is set as a positive direction of the X-axis. Moreover, an origin of the front screen Sc is set at a position of the lower end of the center of the screen Sc.

Moreover, in each of the booths, there is provided with a placement table for keeping and setting the gun type shooting device 26 and the bazooka type shooting device 28, and with a placement table for work on which the gun type shooting device 26 and/or the bazooka type shooting device 28 are temporarily mounted.

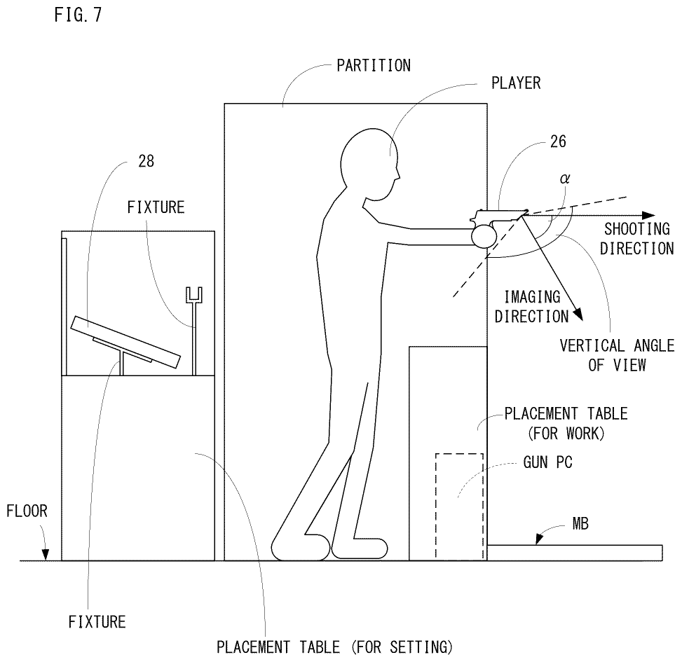

Fixtures (see FIG. 7) for keeping or setting each of the gun type shooting device 26 and the bazooka type shooting device 28 is provided on the placement table, and when not used, the gun type shooting device 26 and/or the bazooka type shooting device 28 are fixed to the fixtures.

Moreover, although the placement table for work is continued for all the booths as shown in FIG. 4, it may be separated for each booth. The player performs shooting in a position behind the placement table for work while being seen from a side of the front screen Sc.

In addition, in FIG. 4, the gun type shooting device 26 and the bazooka type shooting device 28 are omitted. Moreover, although the placement table for setting is provided in an example shown in FIG. 4, by providing only the placement table for work, this placement table for work may also be used as the placement table for setting.

On the floor surface between the placement table for setting or the placement table for work and the front screen Sc, a marker board (hereinafter, referred to as “AR marker board”) MB using an ArUco marker (hereinafter, referred to as “AR marker”). The AR marker board MB is arranged on the floor surface so that a surface printed with the AR marker is turned to an upper direction.

As shown in FIG. 4, the AR marker board MB is of a shape of horizontally long plate or belt having a width longer than a width of all the plurality of booths. In FIG. 4, the AR marker board MB is indicated by a frame of a thick line. However, the AR marker board MB is provided so that one long side is brought into contact with a side at a side of the front screen Sc of the placement table for work and a center in the horizontal direction of the AR marker board MB is made to correspond to a center in the horizontal direction of the front screen Sc (or a center in the horizontal direction of the booth in the middle).

However, the AR marker board MB is constituted in a manner that a plurality of square panels PL are arranged in a matrix, i.e., two-dimensionally. As shown in FIG. 4, each cell corresponds to a panel PL, and a plurality of panels PL are arranged so that panels PL each printed with the AR marker are not continuously located side by side in vertically and horizontally. As to details of the AR marker board MB will be described later. Moreover, an origin of the AR marker board MB is set at a position in the panel PL in a left end column and a corner of the side nearest to the booth.

Moreover, as shown in FIG. 4, in the entertainment facility AF, a plurality of light emitting devices for emitting infrared light toward the AR marker board MB are provided in outsides of one end portion in a longitudinal direction of the AR marker board MB and the other end thereof, respectively. Each of the plurality of light emitting devices is arranged in a direction capable of irradiating the AR marker board MB with infrared light from the above the AR marker board MB. However, each of the plurality of light emitting devices is adjusted to a direction irradiating the infrared light so that the entire AR marker board MB can be uniformly irradiated with the infrared light. In the first embodiment, the plurality of light emitting devices irradiate the AR marker board MB with the infrared light at least when a main story of the shooting game is being executed. However, arrangement positions of the light emitting devices are an example, and the light emitting devices may be arranged on the ceiling.

By thus installing the light emitting devices above the AR marker, it is possible to correctly detect the AR marker also to a distant place as compared with a case where the light emitting device is attached to the shooting device, for example. Therefore, the AR marker can be correctly detected even if a plurality of players play the shooting game side by side.

Furthermore, as shown in FIG. 4, in the entertainment facility AF, each of the plurality of front projectors 20 is arranged in a suitable position below the placement table for work. The arrangement of the plurality of front projectors 20 shown in FIG. 4 is an example, and positions of the plurality of front projectors 20 may be changed in the X-axis direction and/or the Y-axis direction of the world coordinate system if the positions are outside a range where the AR marker board MB is provided and if the front game screen can be displayed with overlapping areas.

Furthermore, as shown in FIG. 4, in the entertainment facility AF, between the AR marker board MB and the front screen Sc, each of the plurality of ceiling projectors 22 is arranged in a suitable position in parallel with the X-axis. The arrangement of the plurality of ceiling projectors 22 shown in FIG. 4 is an example, positions of the plurality of ceiling projectors 22 may be changed in the X-axis direction and/or the Y-axis direction of the world coordinate system if the positions are outside a range where the AR marker board MB is provided and if the ceiling game screen can be displayed with overlapping areas.

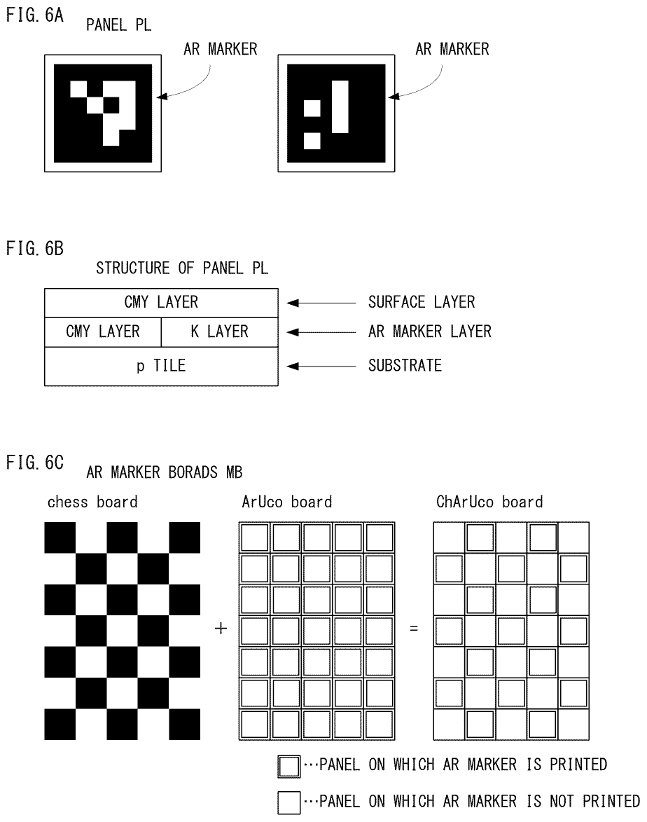

FIG. 6A is a view showing a non-limiting example panel PL that an AR marker is printed. In FIG. 6A, two panels PL that different kinds of AR markers are printed, respectively are illustrated. In the first embodiment, the panel PL is a square and the AR marker is also a square slightly smaller than the panel PL. Moreover, the AR marker is a two-dimensional marker having a specific geometrical feature, i.e., predetermined pattern. More specifically, the AR marker is an image of a binary number describing a specific geometrical pattern generated using a plurality of white squares on a black background. A plurality of AR markers included in the AR marker board MB have different geometrical features, respectively.

FIG. 6B is a view schematically showing a non-limiting example cross section of the panel PL. As shown in FIG. 6B, the panel PL printed with the AR marker is layered structure. A lower most layer is provided with a p-tile that reflects an infrared light as a substrate, and an AR marker layer is printed on the p-tile. The AR marker layer is a layer in which a CMY (Cyan, Magenta, Yellow) layer and a K (black) layer are intermingled horizontally. The CMY layer constituting the AR marker layer is white and transmits the infrared light, and the K layer constituting the AR marker layer is black and absorbs the infrared light. Therefore, in the CMY layer constituting the AR marker, the infrared light reflected on a surface of the p-tile is imaged by the infrared camera of the infrared camera module (26a or 28a). As shown also in FIG. 6B, the CMY layer and the K layer that constitute the AR marker are set as the same or almost same height so that upper surfaces thereof become a uniform plane. An upper most layer that is a surface layer of the panel PL is constituted by a black CMY layer, and transmits the infrared light.

Hereinafter, when there is no necessity of distinguishing the infrared camera modules 26a and 28a, simply referred to as “infrared camera module”.

The upper most layer is thus constituted with the black CMY layer, the panel PL is configured so that the AR marker is not seen by the player. By making a height of an upper surface of the CMY layer and a height of an upper surface of the K layer, both which constitute the AR marker, be the same or almost same, it is possible to prevent the AR marker from being faintly visible.

In addition, the panel PL not printed with the AR marker is two-layer structure of a substrate and a surface layer. However, in order to make a thickness of the panel PL not printed with the AR marker the same as a thickness of the panel PL printed with the AR marker, a thickness of the surface layer of the panel PL not printed with the AR marker is set to be equal to a thickness of a thickness of the surface layer plus a thickness of the AR marker layer of the panel PL printed with the AR marker.

Moreover, a ChArUco board that a chess board as shown in FIG. 6C and an ArUco board that the AR marker is arranged in an array are combined with each other is used as the AR marker board MB. However, in FIG. 6C, the panel PL printed with the AR marker is indicated by a double square frame, and the AR marker is omitted. Moreover, in FIG. 6C, the panel PL not printed with the AR marker is indicated by a simple square frame.

In addition, although it is also considered that the ArUco board is used as the AR marker board MB, it is known that the ChArUco board is more accurate for camera calibration, etc., and according to an experiment, an error in calculating a position of an origin on the ChArUco board is less than that of a case using the ArUco board, so the ChArUco board is used.

FIG. 7 is a view showing a non-limiting example manner that the player plays the shooting game in a certain booth. In an example shown in FIG. 7, the player is playing the shooting game using the gun type shooting device 26. However, FIG. 7 is a view that that certain booth is seen from a side, and the partition at this side of the player is omitted. Moreover, in FIG. 7, the front screen Sc is provided in the right of the player.

As described above, in the booth, the placement table for work is provided ahead of the player, and the gun PC 24 is provided below this placement table for work. However, there may be a case where the front projector 20 is provided together with the gun PC 24. Moreover, in the booth, the placement table for setting is provided behind the player, and the gun type shooting device 26 and the bazooka type shooting device 28 are placed on this placement table for setting. In an example shown in FIG. 7, since the player is using the gun type shooting device 26, only the bazooka type shooting device 28 is fixed or placed on the fixture on the placement table for setting.

Moreover, as shown in FIG. 4, the front screen Sc is provided further forward than the placement table for work, and the player shoots at a target displayed on the front screen Sc in the shooting game according to the first embodiment. As shown in FIG. 5, the front screen Sc is provided upright or vertically on the floor surface. Therefore, in order to shoot at the target displayed on a lower portion of the front screen Sc and to shoot an upper portion of the front screen Sc, the player turns the shooting device either down or up.

Moreover, since the plurality of players perform the shooting game with respect to the horizontally long front screen Sc while being lined side by side as shown in FIG. 4, targets are displayed also in the horizontal direction of the front screen Sc. Therefore, the player can shoot not only the target displayed on the front but the target displayed on the position deviated in the right and left direction of the front screen Sc, and therefore, the player may turn the shooting device to the left or the right.

Since the AR marker board MB has a shorter length in the Y-axis direction of the world coordinate system compared with a length in the X-axis direction of the world coordinate system, the infrared camera is arranged in a direction capable of imaging a vertically long image so as to image the AR marker even if the shooting device is moved to upward. Therefore, the infrared camera is set to have a large angle of view in the vertical direction, i.e., a vertical angle of view compared with an angle of view in the horizontal direction, i.e., a horizontal angle of view. However, since the AR marker board MB is provided on the floor surface, the infrared camera is inclined downward with respect to a shooting direction of the shooting device so that the AR marker board MB can be imaged even if a front or upper target is being aimed at by the shooting device. That is, the infrared camera is arranged in a manner that an imaging direction (or imaging plane) thereof is different from the shooting direction of the shooting device.

FIG. 8A is a view showing non-limiting example structure of the gun type shooting device 26, and FIG. 8B is a view showing non-limiting example structure of the bazooka type shooting device 28.

As shown in FIG. 8A, the gun type shooting device 26 is a controller imitating a gun, and provided with a gun barrel, i.e., a barrel portion 260 and a grip portion 262, and further provided with a trigger 264 in an upper portion of the grip portion 262 and at a side of a gun muzzle 260a. The gun muzzle 260a is provided at a tip end of the barrel portion 260 to be turned diagonally downward. The barrel portion 260 is a shape that an upper side is projected at the tip end ahead than a lower side. An infrared camera module 26a is provided inside the barrel portion 260 at the tip end of the barrel portion 260. As described above, the AR marker board MB is arranged on the floor surface so that the plane printed with the AR marker is turned upward. Moreover, the player performs the shooting toward the target displayed on the front screen Sc. Therefore, the infrared camera module 26a is attached to the shooting device so that the imaging direction is turned downward at a predetermined angle (hereinafter, described as “angle α (alpha)”) with respect to a direction from a rear end toward a front end (tip end) of the gun type shooting device 26, i.e., the shooting direction. That is, the infrared camera module 26a is fixed so that the imaging direction (or imaging plane) of the infrared camera constituting the infrared camera module 26a is inclined downward with respect to the shooting direction by the angle α (alpha). Thus, the infrared camera is provided diagonally downward with respect to the shooting direction of the gun type shooting device 26, and the barrel portion 260 has a shape that the upper side is projected ahead than the lower side at the tip end, and therefore, the gun muzzle 260a provided at the tip end of the barrel portion 260 is made hard to become an obstruction to the infrared camera. Therefore, it is possible to make the AR marker be imaged easily. Moreover, the speaker 26c for outputting a sound from sound emission hole that is provided at a rear end is provided in a rear end portion of the gun type shooting device 26. Moreover, a microswitch that is turned on when pulling the trigger 264, i.e., the trigger switch 26b is provided inside the gun type shooting device 26 near the trigger 264.

Therefore, the player performs the shooting by holding the grip portion 262 of the gun type shooting device 26 with the right hand or the left hand, and hooking the index finger of the hand holding the grip portion 262 on the trigger 264, and then, pulling the trigger 264. At this time, the target is aimed using a gunsight constituted by a front sight 260b provided on an upper portion of a front end of the barrel portion 260 and a rear sight 260c provided on an upper portion of a rear end of the barrel portion 260. That is, the player aligns the front sight 260b with the target (target object 202 described later) and aims at the target so that the convex front sight 260b is visible within a groove of the concave rear sight 260c. Since the infrared camera module 26a is arranged inside the barrel portion 260 as described above, the player can play the shooting game without being conscious of the position of the infrared camera.

As shown in FIG. 8B, the bazooka type shooting device 28 is a controller imitating a bazooka, a grip portion 282 is provided in a lower portion of a front side of a barrel portion 280, and a shoulder pad 284 is provided in a lower portion on a rear side of the barrel portion 280. Moreover, a scope 286 is provided in an upper portion of a center of the barrel portion 280, and a fire button 288 is provided in a slightly rear of the scope 286. A gun muzzle 280a is provided at a tip end of the barrel portion 280 diagonally downward. The barrel portion 280 is a shape that an upper side is projected at the tip end ahead than a lower side. The infrared camera module 28a is provided inside the barrel portion 280 at the tip end of the barrel portion 280. As similar to the infrared camera module 26a, the infrared camera module 28a is fixed so that an imaging direction of an infrared camera constituting the infrared camera module 28a is inclined downward with respect to a shooting direction by the angle α (alpha). However, the shooting direction of the bazooka type shooting device 28 is from a rear end toward a front end (tip end) of the bazooka type shooting device 28. Thus, the infrared camera module 28a is provided diagonally downward with respect to the shooting direction of the bazooka type shooting device 28, and the barrel portion 280 has a shape that the upper side is projected ahead than the lower side at the tip end, and therefore, the gun muzzle 280a provided in the tip end of the barrel portion 280 is made hard to become an obstruction to the infrared camera. Therefore, it is possible to make the AR marker be imaged easily. Moreover, the speaker 28c for outputting a sound from sound emission hole that is provided at a rear end is provided in a rear end portion of the bazooka type shooting device 28. Moreover, a microswitch that is turned on when turning the fire button 288 on, i.e., the trigger switch 28b is provided inside the bazooka type shooting device 28 near the fire button 288.

Therefore, the player performs the shooting by holding the grip portion 282 of the bazooka type shooting device 28 with the right hand or the left hand, and hooking the index finger or the middle finger of a hand opposite to the hand holding the grip portion 282 on the fire button 288 while placing the shoulder pad 284 on the shoulder of the same side as the hand having the finger hooked on the fire button 288, and then, pushing the fire button 288. At this time, the target is aimed using the scope 286. That is, the player looks into the scope 286 to align its center with the target object 202, thereby to aim at the target. Since the infrared camera module 28a is arranged inside the barrel portion 280 as described above, the player can play the shooting game without being conscious of the position of the infrared camera.

Although the gun muzzle of the shooting device is formed as a shape that a cylinder is cut aslant as shown in FIG. 8A and FIG. 8B, it does not need to be limited this. It is possible to adopt a shape that a cylinder is cut in a stepwise more than two steps. However, the barrel portions 260 and 280 each formed into a shape that the upper portion projects ahead than the lower portion at the tip end as shown in FIG. 8A and FIG. 8B, and therefore, it make the gun muzzle hard to become the obstruction to the infrared camera.

In the shooting game, a part of the AR marker board MB is imaged with the infrared camera that constitutes the infrared camera module provided in the shooting device that the player uses, and a position and a posture (Yaw, Pitch, Roll) of the infrared camera in the world coordinate system are calculated based on the imaged image. An intersection point of the front screen Sc and a straight line extended from the infrared camera in a direction that is pointed by the shooting device is calculated based on the position and the posture of the infrared camera. Therefore, when the player performs the shooting using the shooting device, this intersection point on the front screen Sc is made to be an impact point. Since such processing is executed for each shooting device, i.e., for each player, the intersection point (or impact point) is distinguishably calculated for each player. This is true even if the gun PCs 24 are not provided for each player, but one or several high-performance PCs (i.e., fewer than the number of players) are used to distinguishably calculate the intersection point for each player. Therefore, even if the plurality of players play the shooting game simultaneously, the shooting of each player is correctly distinguishable.

Here, a calculation method that the intersection point of the front screen Sc and the straight line extended from the infrared camera in a direction that the shooting device points is calculated based on the imaged image that the AR marker board MB is imaged will be described.

As to the shooting device, imaging processing is performed with a predetermined frame rate in the infrared camera module, and the imaged image is input to the gun PC 24 for each frame. The gun PC 24 analyzes the imaged image and detects the position of the origin and the posture (Yaw, Pitch, Roll) of the AR marker board MB. For this calculation, an image processing library such as OpenCV (Open Source Computer Vision Library) is used. As a programming language, either python or C++ can be used. Moreover, known internal parameters of the infrared camera are given to OpenCV. The internal parameters include a focal distance, an optical center, an aspect ratio, etc. of the infrared camera. Moreover, as described above, sizes of the AR marker board MB and each panel PL constituting the AR marker board MB, a position (this is “center position”) of each panel PL, a size of each AR marker and a position (this is “center position”) of each AR marker in the world coordinate system are also known. That is, the position of each panel PL on the basis of the origin of the AR marker board MB in the world coordinate system is also known. Such known values are also suitably set as the parameters of OpenCV. Moreover, the position of each AR marker is managed in association with identification information (i.e., ID) applied to each AR marker.

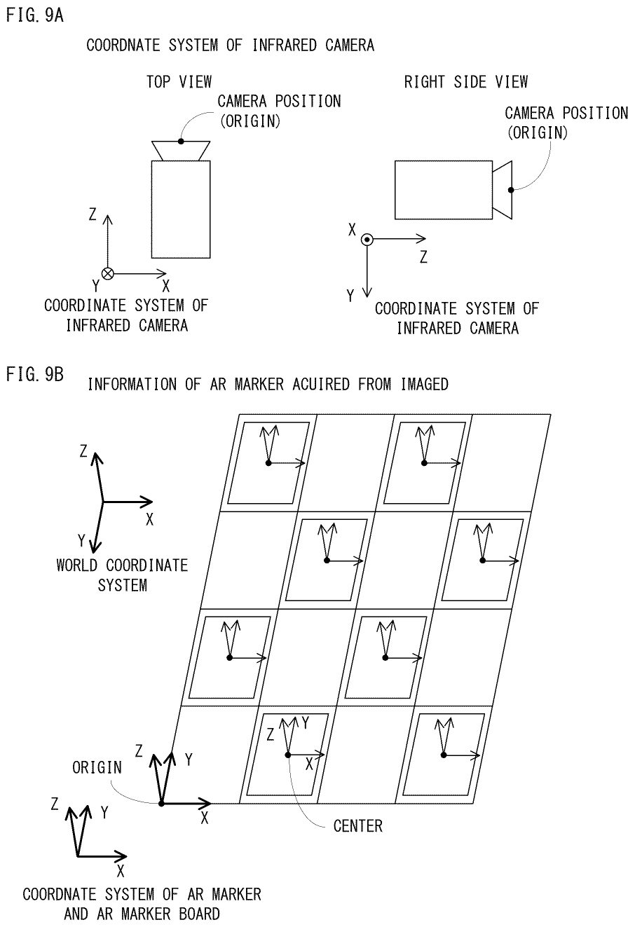

FIG. 9A is a view showing a non-limiting example coordinate system of the infrared camera constituting the infrared camera module, and FIG. 9B is a view showing non-limiting example origin and posture of the AR marker board MB in the imaged image of the AR marker board MB. However, in FIG. 9A, the infrared camera is shown schematically. Moreover, for describing briefly, in FIG. 9B, the AR marker board MB in which four panels PL are arranged vertically and horizontally, respectively. In FIG. 9B, a double square frame shows a panel PL printed with the AR marker, and a simple square frame shows a panel PL not printed with the AR marker.

As shown in FIG. 9A, a center of the imaging plane (sensor) of the infrared camera, i.e., the position of the infrared camera is set to the origin, the imaging direction of the infrared camera is a positive direction of the Z-axis of the infrared camera coordinate system, a rightward direction of the infrared camera when facing the imaging direction is a positive direction of the X-axis of the infrared camera coordinate system, and a downward direction of the infrared camera when facing the imaging direction is a positive direction of the Y-axis of the infrared camera coordinate system.

As shown in FIG. 9B, the origin of the AR marker board MB is a left lower corner when seeing the AR marker board MB from the player side (also see FIG. 4). Moreover, the posture of the AR marker board MB is a direction of a plane of the AR marker board MB at the origin of the AR marker board MB seen from the infrared camera. However, the posture of the AR marker board MB is expressed with angles around respective axes constituting the coordinate system of the AR marker board MB at the origin. A direction of an X-axis of the coordinate system of the AR marker board MB is a longitude direction of the AR marker board MB, and a direction away from the origin is a positive direction of the X-axis. A direction of a Y-axis of the coordinate system of the AR marker board MB is a short side direction of the AR marker board MB, and a direction away from the origin is a positive direction of the Y-axis. Furthermore, a direction of a Z-axis of the coordinate system of the AR marker board MB is a direction perpendicular to both the X-axis and the Y-axis of the AR marker board MB, and a direction away from a plane of AR marker is a positive direction of the Z-axis. An angle around the X-axis of the coordinate system of the AR marker board MB is a roll angle, an angle around the Y-axis is a pitch angle, and an angle around the Z-axis is a yaw angle.

Moreover, each of the plurality of AR markers included in the AR marker board MB has a local coordinate system (i.e., coordinate system of the AR marker) centering on self. In the coordinate system of the AR marker, a rightward direction is a positive direction of an X-axis when seeing the AR marker from the front, an upward direction is a positive direction of a Y-axis, and a direction away from the plane of the AR marker is a positive direction of a Z-axis.

The position of the origin and the posture of the AR marker board MB is calculated based on one or more AR markers included in the imaged image. Although a case where a whole of the AR marker board MB is included in the imaged image in FIG. 9B, it is sufficient to include at least one AR marker in the imaged image.

Based on the AR marker included in the imaged image, an ID of the AR marker is detected, a distance from the position of the infrared camera to the AR marker and an angle of the AR marker seen from the infrared camera are detected. Moreover, the posture of the AR marker is presumed from the angle of the AR marker when seeing from the infrared camera. A positional relationship of each AR marker with respect to the origin of the AR marker board MB is known, and since the posture of the AR marker and the posture of the AR marker board MB correspond to each other, the position of the origin and the posture of the AR marker board MB are calculated based on the position and the posture of the AR marker included in the imaged image. However, when a plurality of AR markers are included in the imaged image, the position of the origin and the posture of the AR marker board MB are calculated using average results of the positions and the postures of the plurality of AR markers. Moreover, in OpenCV, the origin and the posture of the AR marker board MB are calculated in the camera coordinate system that the position of the infrared camera is an origin thereof.

The origin and the posture of the AR marker board MB in the coordinate system of the infrared camera are detected based on the imaged image by the infrared camera using OpenCV. By performing an inverse transformation of the origin and the posture of the AR marker board MB having been detected, the position and the posture (Euler angles) of the infrared camera in the world coordinate system are calculated. However, the posture of the infrared camera in the world coordinate system may be expressed in a rotation matrix.

The shooting direction is calculated from the direction of the infrared camera (i.e., imaging direction) based on the posture of the infrared camera in the world coordinate system. Since the imaging direction of the infrared camera is leaned downwardly by the angle α (alpha) with respect to the shooting direction as described above, the shooting direction is calculated so that such a lean is made to be lost (i.e., to be zero (0) degree). That is, the shooting direction is calculated by turning the imaging direction clockwise by the angle α (alpha) with a rotation axis that is the X-axis of the infrared camera while facing the positive direction of the X-axis.

Subsequently, a straight line extended in the shooting direction passing the position of the infrared camera in the world coordinate system is calculated, and an intersection point of this straight line and the front screen Sc is calculated. At this time, if the shooting is performed by the shooting device, the intersection point of the front screen Sc is to be an impact point of a virtual bullet object by the shooting.

In addition, since the shooting direction may be slightly deviated from a direction of aiming at the target using the gunsight of the shooting device, such deviation may be corrected. It is for making the position that the player aims correspond to the impact point.

Moreover, the intersection point of the straight line extended in the shooting direction passing the position of the virtual camera and the front screen Sc is calculated in the first embodiment; however, an intersection point of a straight line extended in the shooting direction passing a position being offset by the predetermined length from the position of the virtual camera and the front screen Sc may be calculated.

Moreover, although the target object displayed on the front game screen is shot in the first embodiment, the target object displayed on the ceiling game screen may also be shot. In such a case, if the player turns the shooting device to the ceiling, an intersection point of a surface of the ceiling and the shooting direction will be calculated.

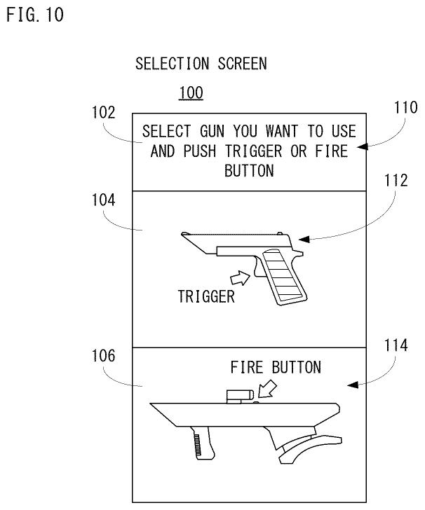

In this first embodiment, prior to a staring the main story of the shooting game, the shooting device is selected. FIG. 10 is a view showing a non-limiting example selection screen 100 of the shooting device. However, the selection screen 100 is vertically long and is displayed on each booth or each player. Therefore, the same numbers of selection screens 100 as the numbers of a plurality of booths are displayed on the front screen Sc side by side in the horizontal direction.

As shown in FIG. 10, the selection screen 100 has three display areas 102, 104 and 106, and these are arranged vertically abreast. A message 110 showing how to determine the shooting device to be used in the shooting game is displayed on the display area 102. In an example shown in FIG. 10, a message 110 describing “Select gun you want to use and push trigger or fire button” is displayed. That is, in the first embodiment, it is possible to determine the shooting device to be used in the shooting game when the player pushes the trigger 264 or the fire button 288 of the shooting device.

In addition, although a detailed description is omitted, when using another shooting device during the play of the shooting game, the shooting device to be used in the shooting game can be changed to a further shooting device by pushing the trigger 264 or the fire button 288 of the further shooting device.

An image 112 of the gun type shooting device 126 is displayed in the display area 104, and an image 114 of the bazooka type shooting device 128 is displayed in the display area 106. Moreover, a character string and an arrow mark image for teaching the player the trigger 264 are displayed in the display area 104. Similarly, a character string and an arrow mark image for teaching the player the fire button 288 are displayed in the display area 106.

If a shooting device is not determined by the player, that is, if the trigger 264 or the fire button 288 of the shooting device is not pulled or pushed after the display of the selection screen 100 is started before exceeding a time limit, a shooting device having been set in advance (e.g., the gun type shooting device 26) is forcedly determined as a shooting device to be used in the shooting game.

When the shooting device that each player uses is determined, the main story of the shooting game is started. FIG. 11A is a view showing a non-limiting example front game screen 200 displayed on the front screen Sc in the shooting game. Moreover, FIG. 11B is a view showing a non-limiting example ceiling game screen 250 displayed on the ceiling in the shooting game.

As shown in FIG. 11A, a plurality of target objects 202 are displayed on the front game screen 200. In FIG. 11A, a background is omitted. On the front game screen 200, as an example, target objects 202 having different sizes are displayed, and if the bullet the player shot hits the target object 202, such a target object 202 will disappears. A score to be added when making a small target object 202 disappear is larger than a score to be added when making a large target object 202 disappear. Each player shoots the target objects 202 and competes for a ranking at a total number of points, i.e., the score determined by the kinds and the numbers of the target objects 202 that are made to disappear. However, when the player performs the shooting, the coordinates of the virtual space corresponding to the intersection point on the front screen Sc that this player pointed by the shooting device is calculated, and when the target object 202 is arranged at the calculated coordinates of the virtual space, it is determined that the bullet that the player shot hits the target object 202.

The front game screen 200 is sectioned per booth as indicated by dotted lines so that the kinds and the numbers of the target objects 202 are equally displayed for each of the plurality of players, and the kinds and the numbers of the target objects 202 displayed in the display areas corresponding to respective booths are made to be equal to each other during the shooting game is being executed. However, the dotted line is not displayed on an actual front game screen 200.

Moreover, since the player can aim at any positions on the front screen Sc, it is possible for the player to shoot not only at the target object 202 displayed on the display area corresponding to the booth where himself/herself exists but at the target object 202 displayed on the display area corresponding to the booths where other players exist.

The front game screen 200 is updated for each frame, and positions and the kinds of the target objects 202 to be displayed are determined in advance according to the number of frames from the start of the shooting game. Therefore, the target object 202 is eliminated according to the elapse of time even if not shot by the player.

As shown in FIG. 11B, an image of the sky is displayed on the ceiling game screen 250, and objects 252 of a plurality of clouds are displayed. Other than the cloud objects 252, objects of stars may be displayed. As described above, although no target object is displayed on the ceiling game screen 250 in the first embodiment, a target object may be displayed. In such a case, the ceiling game screen 250 is sectioned per booth so that the target objects may be equally displayed to each player. The ceiling game screen 250 is also updated for each frame. However, since the ceiling game screen 250 is only displayed with a background image such as an image of the sky in the first embodiment, a moving image having been prepared in advance may be displayed.

FIG. 12 is a view showing a non-limiting example memory map 300 of the RAM 42 of the game control PC 12 shown in FIG. 2. As shown in FIG. 12, the RAM 42 includes a program storage area 302 and a data storage area 304. The program storage area 302 is stored with a game program according to the first embodiment. The game program includes a main processing program 302a, a communication program 302b, an image generation program 302c, an image display program 302d, an operation input detection program 302e, a game control program 302f, a shooting device determination program 302g, a hit determination program 302h, etc.

In addition, the game program may be stored in advance in the HDD 44, or may be acquired from an external memory such as an optical disk, a USB memory or a memory card each attachable to or detachable from the game control PC 12. However, a part of the game program is stored in the HDD 44, and other parts thereof may be acquired from the external memory. These also apply to the image generation data 304b described later.

The main processing program 302a is a program for processing a main routine of the game program of the shooting game according to the first embodiment.

The communication program 302b is a program for communicating with external devices including the front projector drawing PC 16, the ceiling projector drawing PC 18 and the gun PCs 24, in the first embodiment. According to the communication program 302b, the processor 40 transmits the game image data to the front projector drawing PC 16 and the ceiling projector drawing PC 18, transmits activation instructions of the infrared camera to each gun PC 24, receives the intersection point data transmitted from each gun PC 24, and receives data that indicates that the trigger switch 26b or the trigger switch 28b is turned on, i.e., trigger data that is transmitted from each gun PC 24.

The image generation program 302c is a program for generating (or drawing), using the image generation data 304b, game image data corresponding to various kinds of game screens (in the first embodiment, the selection screen 100, the front game screen 200 and the ceiling game screen 250), i.e., the game image.

The image display program 302d is a program for outputting or transmitting the game image data generated according to the image generation program 302b to the front projector drawing PC 16 and the ceiling projector drawing PC 18. Therefore, the selection screen 100 and the front game screen 200 are displayed on the front screen Sc and the ceiling game screen 250 is displayed on the ceiling.

The operation input detection program 302e is a program for detecting operation input data from the input device 48 and operation input data (the intersection point data and the trigger data in the first embodiment) received from each gun PC 24. However, when receiving the operation input data from each gun PC 24, the communication program 302b is also executed.

The game control program 302f is a program for executing game control processing of the shooting game of the first embodiment.

The shooting device determination program 302g is a program for selecting and determining the shooting device that each player wants to use prior to the start of the main story of the shooting game.

The hit determination program 302h is a program for determining for each player, when each player performs the shooting, whether the bullet by the shooting hits the target object 202.

Although illustration is omitted, the program storage area 302 is stored with other programs, such as a sound output program for generating and outputting a sound required in the virtual game, etc. Moreover, the program storage 302 is also stored with the firmware or OS, the middleware, etc.

Moreover, the data storage area 304 is stored with the operation input data 304a, the image generation data 304b, target object data 304c, score data 304d, etc.

The operation input data 304a is data that is input from the input device 48, and is stored according to a time series. Moreover, the operation input data 304a includes the intersection point data and the trigger data that are input from each of the gun PCs 24 (i.e., each image processing PC 24a), and is stored according to a time series with making each gun PC 24 or booth distinguishable. The operation input data 304a is eliminated if used for processing by the processor 40.

The image generation data 304b includes data for generating the game image data such as polygon data and texture data, etc. Moreover, the image generation data 304b also includes data regarding timings that the target objects 202 are to be displayed, data of a position and a kind of each of the plurality of target objects 202 to be displayed, etc., in the shooting game. However, the timing is the number of frames from the start of the main story of the shooting game.

The target object data 304c is data regarding the position and the kind of each target object 202 that is being currently displayed on the front game screen 200. The target object data 304c is updated at each timing, or when the corresponding target object 202 is shot.

The score data 304d is data regarding the score of the shooting game, which is made to be distinguishable for each gun PC 24 or booth.

Although illustration is omitted, the data storage area 304 is stored with other data required for executing the game program, and is provided with a counter(s) or a timer(s).

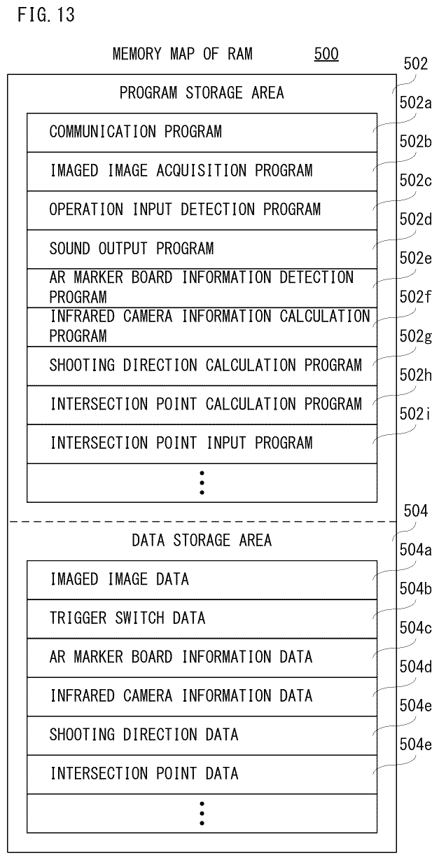

FIG. 13 is a view showing a non-limiting example memory map 500 of the RAM 242 of image processing PC 24a shown in FIG. 3. As shown in FIG. 13, the RAM 242 includes a program storage area 502 and a data storage area 504. The program storage area 502 is stored with an information processing program executed by the image processing PC 24a included in the gun PC 24 of the first embodiment. The information processing program includes a communication program 502a, an imaged image acquisition program 502b, an operation input detection program 502c, a sound output program 502d, an AR marker board information detection program 502e, an infrared camera information calculation program 502f, a shooting direction calculation program 502g, an intersection point calculation program 502h, an intersection point input program 502i, etc.

In addition, the information processing program may be stored in advance in a non-volatile such as an HDD or an SSD, or may be acquired from an external memory such as an optical disk, a USB memory or a memory card each attachable to or detachable from the image processing PC 24a. However, a part of the information processing program is stored in the HDD or SSD, and other parts thereof may be acquired from the external memory.

The communication program 502a is a program for communicating with external devices including the game control PC 12 and communicating with the signal processing PC 24b that constitutes the gun PC 24, in the first embodiment.

The imaged image acquisition program 502b is a program for acquiring data of the imaged image from the infrared camera module 26a and/or the infrared camera module 28a.

The operation input detection program 502c is a program for detecting operation input data of the trigger switch 26b or the trigger switch 28b (trigger data 504a described later) that is input from the signal processing PC 24b.

The sound output program 502d is a program for outputting, when the trigger switch 26b or the trigger switch 28b is turned on, sound data of a shooting sound to the speaker 26c or the speaker 28c via the signal processing PC 24b.

The AR marker board information detection program 502e is an image processing library such as OpenCV, and is a program for calculating, based on the AR marker included in the imaged image, information of the AR marker board MB, i.e., the position of the origin and the posture of the AR marker board MB in the camera coordinate system.

The infrared camera information calculation program 502f is a program for calculating information of the infrared camera, i.e., the position and the posture of the infrared camera in the world coordinate system based on the AR marker board information detected according to the AR marker board information detection program 502e.

The shooting direction calculation program 502g is a program for calculating the shooting direction based on the information of the infrared camera calculated according to the infrared camera information calculation program 502f.

The intersection point calculation program 502h is a program for calculating a position on the front screen Sc pointed by the shooting device. That is, the intersection point calculation program 502h is a program for calculating the intersection point of the front screen Sc and the straight line that passes the position of the infrared camera included in the information of the infrared camera calculated according to the infrared camera information calculation program 502f and extended in the shooting direction calculated according to the shooting direction calculation program 502g.

The intersection point input program 502i is a program for inputting or transmitting data of the intersection point calculated according to the intersection point calculation program 502h to the game control PC 12. At this time, the communication program 502a is also executed.

Although illustration is omitted, the program storage area 502 is stored with other programs needed in the information processing. Moreover, the program storage 502 is also stored with the OS, the middleware, etc.

Moreover, the data storage area 504 is stored with imaged image data 504a, trigger data 504b, AR marker board information data 504c, infrared camera information data 504d, shooting direction data 504e, intersection point data 504f, etc.

The imaged image data 504a is data of the imaged image acquired from the infrared camera module 26a and/or the infrared camera module 28a. It is made to be distinguishable whether the imaged image data is acquired from the infrared camera module 26a or the infrared camera module 28a.

The trigger data 504b is data that is input from the signal processing PC 24b to indicate that the trigger switch 26b or the trigger switch 28b is turned on.

The AR marker board information data 504c is data regarding the information on the AR marker board MB calculated based on the imaged image, and specifically, data regarding the position of the origin and the posture of the AR marker board MB in the camera coordinated system of the infrared camera included in the infrared camera module 26a or the infrared camera module 28a from which the imaged image is acquired.

The infrared camera information data 504d is data regarding the information of the infrared camera calculated from the AR marker board information data 504c, and specifically, data regarding the position and the posture of the infrared camera in the world coordinated system.

The shooting direction data 504e is data regarding the shooting direction of the shooting device calculated based on the infrared camera information data 504d.

The intersection point data 504f is coordinate data of the intersection point on the front screen Sc pointed by the shooting device.

Although illustration is omitted, the data storage area 504 is stored with other data required for the information processing such as sound data of a shooting sound, and is provided with a counter(s) or a timer(s).

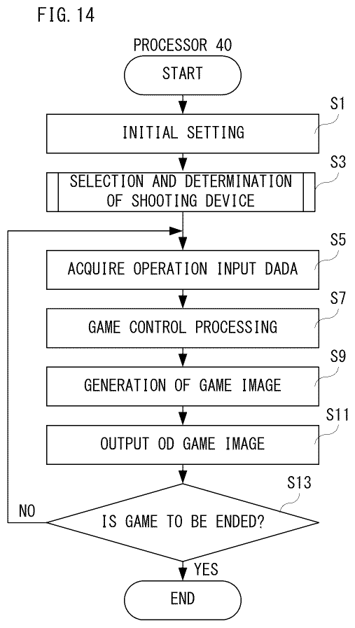

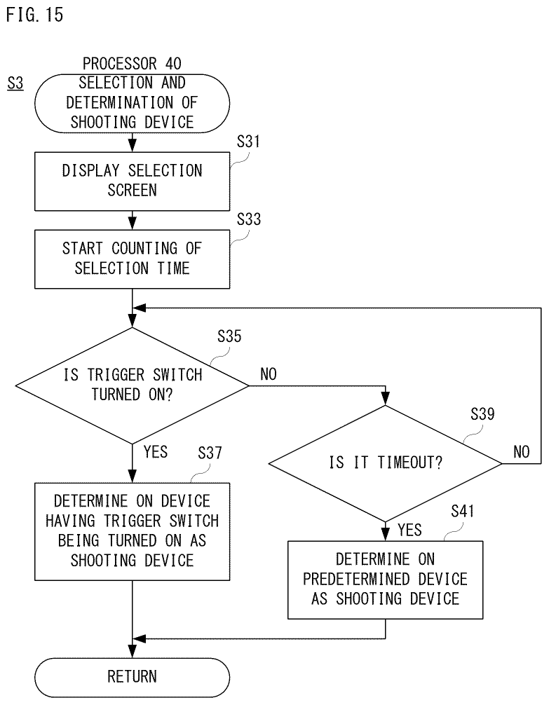

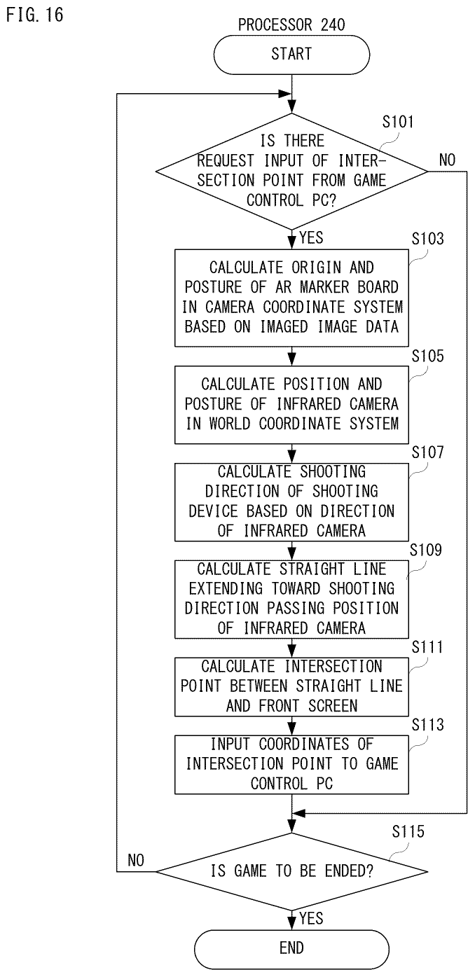

FIG. 14 is a flowchart showing non-limiting example processing of the game program (overall processing) executable by the processor 40 of the game control PC 12 shown in FIG. 2. FIG. 15 is a flowchart showing non-limiting example shooting device selection and determination processing executable by the processor 40 of the game control PC 12 shown in FIG. 2. FIG. 16 is a flowchart showing non-limiting example intersection point calculation and input processing executable by the processor 240 of the image processing PC 24a shown in FIG. 3.

However, processing of respective steps of the flowcharts shown in FIG. 14-FIG. 16 are mere examples, and if the same or similar result is obtainable, an order of the respective steps may be exchanged. Moreover, in the first embodiment, it will be described that the processing of the respective steps of the flowcharts shown in FIG. 14 and FIG. 15 are basically executed by the processor 40; however, some steps may be executed by a processor(s) and/or a dedicated circuit(s) other than the processor 40. Similarly, it will be described that the processing of the respective steps of the flowchart shown in FIG. 16 are executed by the processor 240; however, some steps may be executed by a processor(s) and/or a dedicated circuit(s) other than the processor 240.

The game control PC 12 starts the overall processing when the execution of the game program of the first embodiment is instructed by the staff etc. of the entertainment facility AF to which the shooting game system 10 is applied. As shown in FIG. 13, if the overall processing is started, the processor 40 executes initial setting in a step S1. Here, the processor 40 reads the image generation data 304b from the HDD 44 and stores the same in the RAM 42. Moreover, the processor 40 eliminates the operation input data 304a and the score data 304f having been stored in the execution of the last overall processing (i.e., shooting game). Furthermore, the processor 40 notifies a game start to each gun PC 24 (i.e., image processing PC 24a) when the overall processing is started.

In a subsequent step S3, the shooting device selection and determination processing described later (see FIG. 15) is executed. However, the shooting device selection and determination processing is individually and parallelly executed for each booth (i.e., gun PC 24).

In a next step S5, the processor 40 acquires the operation input data that is transmitted or input from each gun PC 24, and executes the game control processing in a step S7. The processor 40 determines, in the game control processing, whether the bullet hits the target object 202 according to a shooting operation of the player. Specifically, when the player performs the shooting, that is, when the trigger data is included in the operation input data 304, a position of the intersection point on the front screen Sc that the player points is acquired from the intersection point data included in the operation input data 304a, the coordinates in the virtual space corresponding to the intersection point data is calculated, and determined whether the target object 202 is arranged at the calculated coordinates. When the bullet hits the target object 202, the processor 40 executes processing eliminating the target object 202, and adds a corresponding score to the player that shot that target object 202, i.e., the gun PC 24 or the booth. Such the game control processing is individually executed for each player, i.e., for each gun PC 24.

In a next step S9, generation processing of the game image. Here, the processor 40 generates (or updates) the game image data based on a result of the game processing in the step S7, i.e., the game image data corresponding to the front game screen 200 and the game image data corresponding to the ceiling game screen 250. However, some target objects 202 are eliminated according to the elapse of the time even if not shot, and other target objects 202 may be newly displayed.

Subsequently, in a step S11, the game image is output. Here, the processor 40 outputs the game image data corresponding to the front game screen 200 that is generated in the step S9 to the front projector drawing PC 16 and outputs the game image data corresponding to the ceiling game screen 250 that is generated in the step S9 to the ceiling projector drawing PC 18.

Then, in a step S13, it is determined whether the game is to be ended. Here, the processor 40 determines whether the process proceeds up to the end of the main story of the shooting game. If “NO” is determined in the step S13, that is, if the game is not to be ended, the process returns to the step S5. On the other hand, if “YES” is determined in the step S13, that is, if the game is to be ended, the overall processing is terminated. When the game is to be ended, the processor 40 notifies the end of the game to each gun PC 24 (i.e., image processing PC 24a).

As shown in FIG. 15, if the shooting device selection and determination processing is started, the processor 40 displays, in a step S31, the selection screen 100 as shown in FIG. 10. However, in the step S31, the processor 40 generates the game image data that the same numbers of selection screens 100 as the plurality of booths are displayed side by side, and outputs the game image data to the front projector drawing PC 16.

In a next step S33, counting of a selection time is started. In a next step S35, it is determined whether the trigger switch 26b or the trigger switch 28b is turned on. If “YES” is determined in the step S35, that is, if the trigger switch 26b or the trigger switch 28b is turned on, in a step S37, a shooting device having the trigger switch 26b or the trigger switch 28b that is turned on is determined as the shooting device to be used in the shooting game, and then, the process returns to the overall processing. The processor 40 transmits, when the shooting device is determined in the step S37, an instruction to activate the infrared camera of that shooting device in the game mode to the gun PC 24. This is true also for a step S41.

On the other hand, if “NO” is determined in the step S35, that is, the trigger switch 26b and the trigger switch 28b are not turned on, it is determined, in a step S39, whether it is a timeout. That is, the processor 40 determines whether the selection time exceeds the time limit.

If “NO” is determined in the step S39, that is, if it is not a timeout, the process returns to the step S35. On the other hand, if “YES” is determined in the step S39, that is, if it is a timeout, a shooting device having been set in advance (e.g., gun type shooting device 26) is determined as the shooting device to be used in the step S41, and the process returns to the overall processing.

The intersection point calculation and input processing of the processor 240 of image processing PC 24a shown in FIG. 16 is executed in parallel to the overall processing by the processor 40 of the game control PC 12 shown in FIG. 14. Although illustration and description are omitted, since the coordinates of the intersection point is used when the processor 40 of the game control PC 12 executes the game control processing, when executing processing (S5) for acquiring the operation input data, requests the processor 240 of each of the image processing PCs 24a to input the intersection point.

In addition, the processor 240 of the image processing PC 24a also executes the communication processing that performs transmission and/or reception of a signal or data between the game control PC 12, the signal processing PC 24b and the infrared camera module of each of the shooting devices, respectively; however, a flowchart of the communication processing and a description of this flowchart will be omitted. Such the communication processing is executed in parallel to the intersection point calculation and input processing.

As described above, the processor 40 of the game control PC 12 notifies the game start to each gun PC 24 (i.e., image processing PC 24a) when the overall processing is started. In response to this, as shown in FIG. 16, the processor 240 of the image processing PC 24a starts the intersection point calculation and input processing, and determines, in a step S101, whether there is any request to input the intersection point from the game control PC 12.

If “NO” is determined in the step S101, that is, if there is no request to input the intersection point from the game control PC 12, the process proceeds to a step S115. On the other hand, if “YES” is determined in the step S101, that is, if there is a request to input the intersection point from game control PC 12, the position of the origin and the posture of the AR marker board MB in the camera coordinate system are calculated in a step S103 based on the imaged image data.

In a next step S105, the position and the posture of the infrared camera in the world coordinate system are calculated. As described above, the processor 240 performs the inverse transformation of the position of the origin and the posture of the AR marker board MB having been calculated in the step S103.

In a subsequent step S107, the shooting direction of the shooting device is calculated based on the direction of the infrared camera, i.e., the Z-axis direction of the infrared camera in the world coordinate system. As described above, the processor 240 calculates the shooting direction by turning clockwise the Z-axis direction of the infrared camera, i.e., the imaging direction by the angle α (alpha) with the rotation axis that is the X-axis of the infrared camera while facing the positive direction of the X-axis.

Subsequently, the straight line extended in the shooting direction passing the position of the infrared camera is calculated in a step S109. Then, in a step S111, the intersection point of the straight line calculated in the step S109 with the front screen Sc is calculated. Furthermore, the coordinates of the intersection point calculated in the step S111 is input or transmitted to the game control PC 12 in a step S113.

In a subsequent step S115, it is determined whether the game is to be ended. Here, the processor 240 determines whether an end of the game is notified from the game control PC 12. If “NO” is determined in the step S115, the process returns to the step S101. On the other hand, if “YES” is determined in the step S115, the intersection point calculation and input processing is ended.

In addition, the intersection point calculation and input processing is individually executed in each gun PC 24 (i.e., image processing PC 24a).

Moreover, the intersection point is calculated and input when there is a request of the input of the intersection point from the game control PC12 in the first embodiment; however, the intersection point is calculated for each frame after the game is started, and the calculated intersection point may be input only when there is a request of the input of the intersection point from game control PC 12. Specifically, the step S101 may be moved between the steps S111 and S113 in the intersection point calculation and input processing shown in FIG. 16, and if “NO” is determined in the step S101, the process returns to the step S103, and if “YES” is determined in the step S101, the process proceeds to the step S113.

According to the first embodiment, the AR marker board is imaged by the infrared camera provided in the shooting device, and the intersection point on the front screen pointed by the shooting device is calculated based on the imaged image, and therefore, it is possible to identify where each player has shot on the front screen. Therefore, even if the plurality of players play the shooting game simultaneously, the shooting of each player is correctly distinguishable.

In addition, although the player plays the shooting game by selecting one shooting device from the two types of shooting devices in the first embodiment, only one type of shooting device may be used, and one shooting device selected from three or more types of shooting devices may be used.

Moreover, although the screen having a flat plane screen is used as the front screen Sc in the first embodiment, a screen having a curved plane may be used. That is, the front screen Sc is provided with a curved shape in the longitudinal direction. In such a case, an intersection point of a straight line extended in the shooting direction passing the position of the infrared camera and the curved plane is calculated, and a component in the X-axis of the intersection point is converted into the coordinates of a case where a portion being curved is extended into a straight. Even in a case of the curved shape, since the AR marker board MB is provided on the floor surface, it is possible for the plurality of players lined side by side to easily see up to ends of the front screen Sc without affecting the imaging of the AR marker.

Furthermore, the marker board is constituted with a plurality of panels printed with a predetermined pattern such as an AR marker in the first embodiment; however, since it is sufficient to obtain identification information from the AR marker, instead of the AR marker, the marker board may be constituted by a plurality of panels printed with a predetermined pattern such as a two-dimensional code (QR code) or a one-dimensional code (barcode). However, the codes respectively printed on the plurality of panels are codes having different information from each other.

Furthermore, although the infrared camera is provided in the shooting device to image the AR marker in the first embodiment, it does not need to be limited to this. Instead of the infrared camera, a color camera (RGB camera) may be used. In such a case, no surface layer of panel PL is provided so as to make the AR marker visible.

### Second Embodiment

Since a shooting game system 10 of the second embodiment is the same or similar to those of the first embodiment except a method for selecting and determining the shooting device, a duplicate description is omitted in the following.

Briefly describing, in the second embodiment, the player selects one shooting device and performs the shooting toward the selection screen 100 by the selected shooting device, whereby this shooting device can be determined as the shooting device to be used in the shooting game. That is, the player selects and determines the shooting device to be used in the shooting game by performing the same operation as an operation of shooting in the shooting game.

In addition, in the second embodiment, since the shooting is performed also when selecting and determining the shooting device, the plurality of light emitting devices irradiate the AR marker board MB with infrared light from the time of starting the overall processing of the game program of the shooting game.

When starting the processing of selecting and determining the shooting device, the infrared camera provided in the gun type shooting device 26 and the infrared camera provided in the bazooka type shooting device 28 are activated in a mode for selecting and determining the shooting device (hereinafter, referred to as “selection mode”). In the selection mode, a frame rate of the infrared camera is set to be lower than frame rate in a case of the game mode that the shooting game is played.

This is because that the shooting device is only determined in the selection mode and it is not necessary to make a frame rate high. Therefore, even if the plurality of players select and determine the shooting devices simultaneously, it is possible to reduce the processing load while preventing a degradation of the gaming experience.

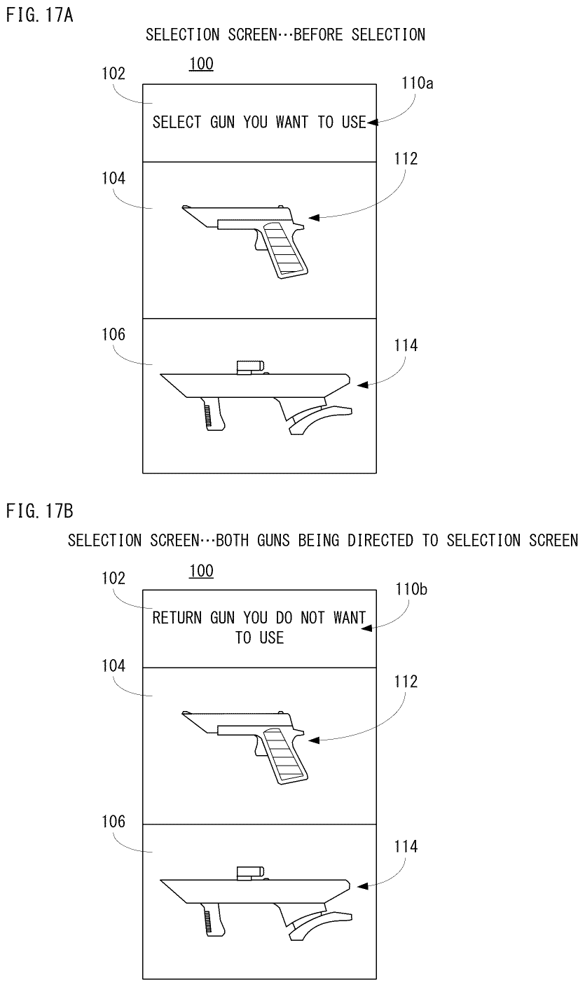

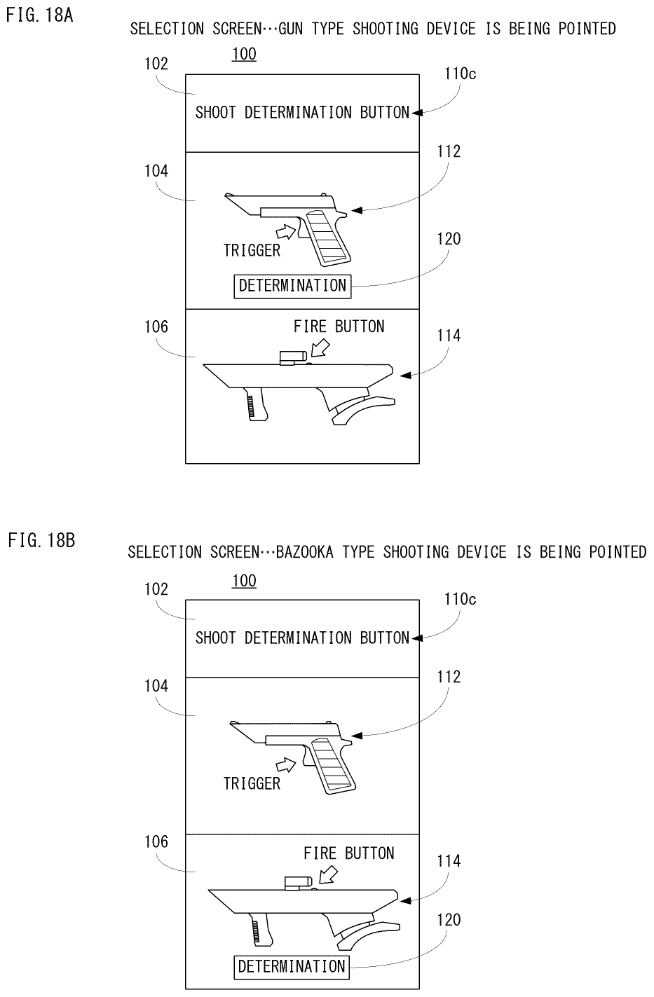

FIG. 17A is a view showing a non-limiting example selection screen 100 that is displayed at the beginning that the processing for selecting and determining the shooting device is started, and FIG. 17B is a view showing a non-limiting example selection screen 100 that is displayed when both shooting devices are turned to the selection screen 100. FIG. 18A is a view showing a non-limiting example selection screen 100 when the gun type shooting device 26 is turned to the selection screen 100, and FIG. 18B is a view showing a non-limiting example selection screen 100 when the bazooka type shooting device 28 is turned to the selection screen 100.

Since each of FIG. 17A, FIG. 17B, FIG. 18A and FIG. 18B is almost the same as the selection screen 100 shown in FIG. 10, a duplicate description will be omitted.

In the selection screen 100 shown in FIG. 17A, a message 110a indicating that the shooting device to be used is selected is displayed on the display area 102. In FIG. 17A, a message 110a describing “Select gun you want to use” is displayed.

In the selection screen 100 shown in FIG. 17B, when both the shooting devices are turned to the selection screen 100, a message 110b that urges the player to return the shooting device not to be used to its setting place is displayed in the display area 102. In FIG. 17B, a message 110b “Return gun you do not want to use” is displayed.

In the selection screen 100 shown in FIG. 18A, when the gun type shooting device 26 is turned to the selection screen 100, a message 110c that urges the player to shoot the determination button 120 so as to determine the gun type shooting device 26 as the shooting device to be used in the shooting game is displayed in the display area 102. In FIG. 18A, a message 110c “Shoot determination button” is displayed.

In the selection screen 100 shown in FIG. 18B, when the bazooka type shooting device 28 is turned to the selection screen 100, a message 110c that urges the player to shoot the determination button 120 so as to determine the bazooka type shooting device 28 as the shooting device to be used in the shooting game is displayed in the display area 102. In FIG. 18B, a message 110c “Shoot determination button” is displayed.

If the determination button 120 is shot using the gun type shooting device 26 in a state where the selection screen 100 shown in FIG. 18A is being displayed, the gun type shooting device 26 is determined as the shooting device to be used in the shooting game.

Moreover, if the determination button 120 is shot using the bazooka type shooting device 28 in a state where the selection screen 100 shown in FIG. 18B is being displayed, the bazooka type shooting device 28 is determined as the shooting device to be used in the shooting game.

Moreover, when the shooting device is not determined by the player from a time that the selection screen 100 is displayed until exceeding the time limit, it is determined whether one shooting device is turned to the selection screen 100. When one shooting device is turned to the selection screen 100, the one shooting device is determined as the shooting device to be used in the shooting game. When both shooting devices are turned to the selection screen 100, or when both shooting devices are not turned to the selection screen 100, the shooting device that is set in advance (e.g., gun type shooting device 26) is determined as the shooting device to be use for the shooting game.

If the shooting device to be use for the shooting game is determined, the infrared cameras of both shooting devices are temporarily stopped, and the infrared camera of the shooting device to be use for the shooting game is activated in the game mode.

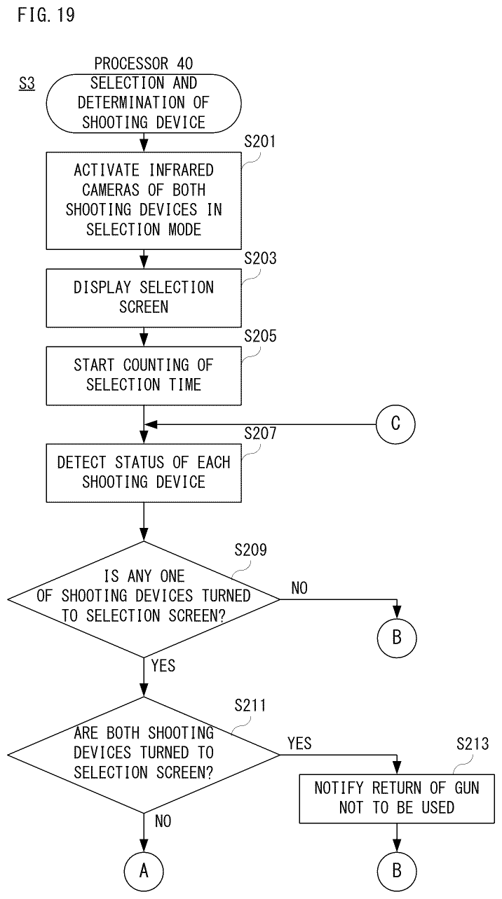

Specifically, the processor 40 of the game control PC 12 in the second embodiment executes shooting device selection and determination processing shown in FIG. 19-FIG. 21. That is, in the second embodiment, the processor 40 of the game control PC 12 executes the shooting device selection and determination processing shown in FIG. 19-FIG. 21 instead of the shooting device selection and determination having been described with FIG. 15. This shooting device selection and determination processing shown in FIG. 19-FIG. 21 is also executed individually and parallelly for each booth (i.e., gun PC 24).

As shown in FIG. 19, if shooting device selection and determination processing is started, the processor 40 activates, in a step S201, the infrared camera of both shooting devices in the selection mode. In a next step S203, the selection screen 100 as shown in

FIG. 17A is displayed on the front screen Sc, and counting of a selection time is started in a step S205.

Subsequently, a state of each shooting device is detected in a step S207. Here, the processor 40 determines whether the shooting device is turned to the selection screen 100. That is, the processor 40 determines whether the intersection point on the front screen Sc being pointed by the shooting device is overlapped with the selection screen 100. However, this selection screen 100 is a selection screen 100 corresponding to the booth provided with the shooting device. As described in the first embodiment, in parallel to the overall processing by the processor 40 of the game control PC 12, the intersection point calculation and input processing of the processor 240 of the image processing PC 24a shown in FIG. 16 is executed, and although illustration is omitted, also when the processor 40 of the game control PC 12 executes processing (S207) for detecting a status of each shooting device, it is required for the processor 240 of each of the image processing PCs 24a to input the intersection point. These are also true for a step S231 described later.

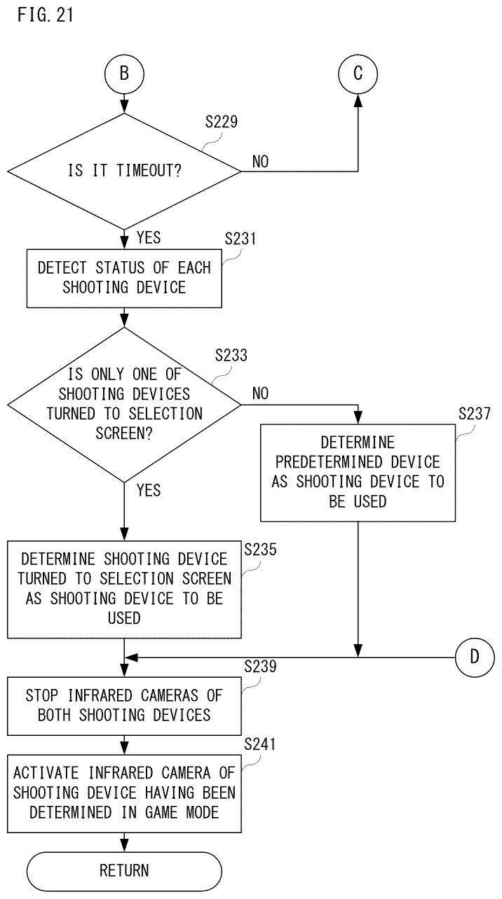

In a next step S209, it is determined whether any shooting device is turned to the selection screen 100. If “NO” is determined in the step S209, that is, if both shooting devices are not turned to the selection screen 100, the process proceeds to a step S229 shown in FIG. 21.

On the other hand, if “YES” is determined in the step S209, that is, if any shooting device is turned to the selection screen 100, it is determined, in a step S211, whether both shooting devices are turned to the selection screen 100.

If “YES” is determined in the step S211, that is, if both shooting devices are turned to the selection screen 100, it is notified that the shooting device that the player does not want to use is to be restored in a step S213, and then, the process proceeds to the step S229. In the step S213, the processor 40 displays the selection screen 100 as shown in FIG. 17B on the front screen Sc.

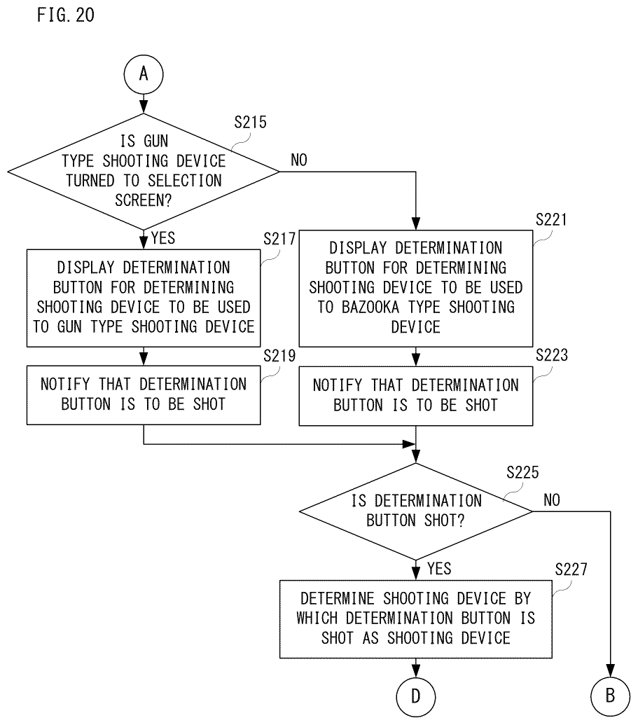

On the other hand, if “NO” is determined in the step S211, that is, if only one shooting device is turned to the selection screen 100, it is determined, in a step S215 shown in FIG. 20, whether the gun type shooting device 26 is turned to the selection screen 100.

If “YES” is determined in the step S215, that is, if the gun type shooting device 26 is turned to the selection screen 100, the determination button 120 for determining the gun type shooting device 26 as the shooting device to be used in the shooting game is displayed in a step S217, and it is notified that the determination button 120 is to be shot in a step S219, and then, the process proceeds to a step S225. In the step S217 and the step S219, the processor 40 displays the selection screen 100 as shown in FIG. 18A on the front screen Sc.

On the other hand, if “NO” is determined in the step S215, that is, if the bazooka type shooting device 28 is turned to the selection screen 100, the determination button 120 for determining the bazooka type shooting device 28 as the shooting device to be used in the shooting game is displayed in a step S221, and it is notified that the determination button 120 is to be shot in a step S223, and then, the process proceeds to the step S225. In the step S221 and the step S223, the processor 40 displays the selection screen 100 as shown in FIG. 18B on the front screen Sc.

In the step S225, it is determined whether the determine button 120 is shot. If “NO” is determined in the step S225, that is, if the determination button 120 is not shot, the process proceeds to the step S229.

On the other hand, “YES” is determined in the step S225, that is, if the determination button 120 is shot, the shooting device by which the determination button 120 is shot is determined as a shooting device to be used in the shooting game in a step S227, and the process proceeds to a step S239 shown in FIG. 21.

As shown in FIG. 21, in the step S229, it is determined whether it is a timeout. If “NO” is determined in the step S229, the process returns to the step S207. On the other hand, if “YES” is determined in the step S229, a status of each shooting device is detected in the step S231.

In a subsequent step S233, it is determined whether only one shooting device is turned to the selection screen 100. If “YES” is determined in the step S233, that is, if only one shooting device is turned to the selection screen 100, the shooting device that is turned to the selection screen 100 is determined as the shooting device to be used in the shooting game in a step S235, and the process proceeds to the step S239.

On the other hand, if “NO” is determined in the step S233, that is, if both shooting devices are turned to the selection screen 100 or if both shooting devices are not turned to the selection screen 100, a shooting device having been set in advance (e.g., gun type shooting device 26) is determined as a shooting device to be used in the shooting game in a step S237, and the process proceeds to the step S239.

In the step S239, the infrared cameras of both shooting devices are stopped. In a next step S241, the infrared camera of the shooting device having been determined to be used in the shooting game is activated in the game mode, and the process returns to the overall processing.

As similar to the first embodiment, in also the second embodiment, even if the plurality of players play the shooting game simultaneously, shooting of each player is correctly distinguishable.

Moreover, in the second embodiment, a frame rate of the infrared camera in the selection mode is made to be lower than a frame rate in the game mode, and the shooting device to be used in the shooting game is determined by a shooting operation similar to those of the main story of the shooting game, and therefore, it is possible to reduce the processing load while preventing a degradation of a game experience

### Third Embodiment

A shooting game system 10 of the third embodiment is the same or similar to the first embodiment or the second embodiment except for execution of processing in a shooting device return mode (i.e., return processing) that it is determined whether the shooting device is returned after the shooting game is ended, and therefore, a duplicate description is omitted.

Briefly describing, in the third embodiment, the return processing is executed when the shooting game is ended, which determines, in a state where the infrared camera of the shooting device that the player used in the shooting game is being activated, whether the shooting device is arranged in a predetermined position based on an image that is imaged by the infrared camera. Moreover, during the execution of the return processing, a return screen for notifying the shooting device is to be returned is displayed on the front screen Sc. The return processing is executed for each booth (or gun PC 24).

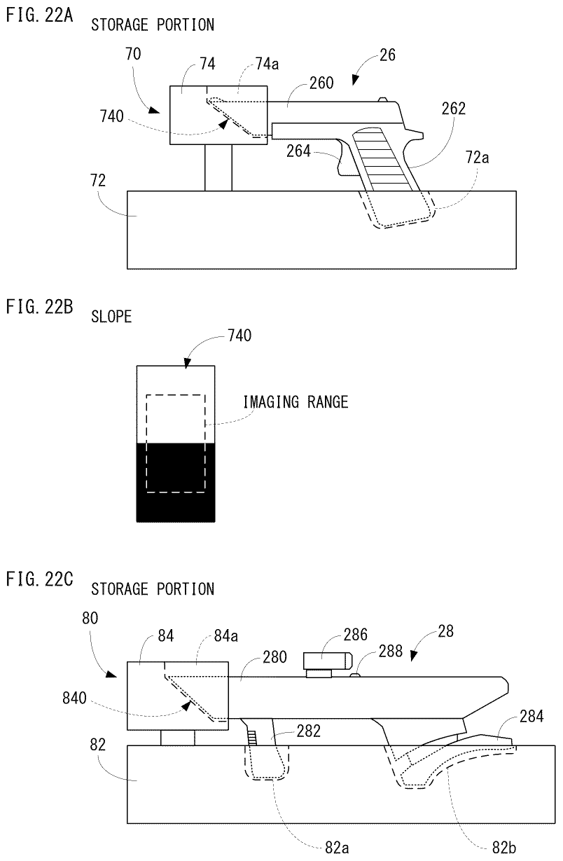

The predetermined position is a placement position on a storage base provided on the placement table for setting. FIG. 22A is a view showing non-limiting example schematic structure of the gun type shooting device 26 and a storage base 70 thereof, FIG. 22B is a view showing a non-limiting example color of a slope 740 of a groove 74a formed in a support portion 74 that supports a part of the gun type shooting device 26 including a tip end thereof, and FIG. 22C is a view showing non-limiting example schematic structure of the bazooka type shooting device 28 and a storage base 80 thereof.

As shown in FIG. 22A, the storage base 70 includes a pedestal 72, and the pedestal 72 is provided with a concave portion 72a that stores a part of the grip portion 262 of the gun type shooting device 26. Moreover, the pedestal 72 is provided with the supporting portion 74 that supports a part of the barrel portion 260 including a tip end of the gun type shooting device 26, and the support portion 74 is provided with the groove 74a for supporting a part of the barrel portion 260 including the tip of the gun type shooting device 26. That is, the gun type shooting device 26 is placed on the storage base 70 from the above.

As shown in FIG. 22B, the slope 740 of the groove 74a, i.e., a part of a plane opposite to the imaging plane of the infrared camera of the gun type shooting device 26 is made into black that absorbs the infrared light, and other portion of the slope 740 is made into a color that does not absorb the infrared light (e.g., white). However, the slope 740 is colored so that a black portion is included in a part of an imaging range of the infrared camera and a white portion is included in other parts. Therefore, when the gun type shooting device 26 is placed on the storage base 70, an image that includes a part of black is imaged with the infrared camera. That is, when the return processing is being executed, if an image that includes a part of black is imaged, it is determined that the gun type shooting device 26 is placed on the storage base 70, that is, returned. If the gun type shooting device 26 is returned on the storage base 70, the infrared camera of the gun type shooting device 26 is stopped, thereby to end the return processing.

However, a pattern of the slope 740 colored with black and white is an example, and black and white colors may be reversed. Moreover, it may be considered that make the slope 740 entirety into black, but a part of the slope 740 is white because it is indistinguishable from a case where the player blocks the gun muzzle with hand. However, since it is also considered that the player blocks a part of the gun muzzle with hand, a simple figure such as a circle or triangle, or a simple symbol such as “A” or “B” is indicated with black in a position settled in the imaging range, and it may be determined that the shooting device is placed on the storage base 70 when such a figure or symbol is detected based on the imaged image.

As shown in FIG. 22C, a storage base 80 includes a pedestal 82, and the pedestal 82 is provided with a concave portion 82a that stores a part of the grip portion 282 of the bazooka type shooting device 28 and a concave portion 82b that stores a part of a shoulder pad. Moreover, the pedestal 82 is provided with a supporting portion 84 that supports a part of the barrel portion 280 including a tip of the bazooka type shooting device 28, and the support portion 84 is provided with a groove 84a for supporting a part of the barrel portion 280 including the tip of the bazooka type shooting device 28. That is, the bazooka type shooting device 28 is placed on the storage base 80 from the above.

A slope 840 of the groove 84a, i.e., a part of a plane opposite to the imaging plane of the infrared camera of the bazooka type shooting device 28 is made into black that absorbs the infrared light, and other portion of the slope 840 is made into a color that does not absorb the infrared light (e.g., white). Therefore, when the bazooka type shooting device 28 is placed on the storage base 80, an image that includes a part of black is imaged with the infrared camera. That is, when the return processing is being executed, if an image that includes a part of black is imaged, it is determined that the bazooka type shooting device 28 is placed on the storage base 80, that is, returned. If the bazooka type shooting device 28 is returned on the storage base 80, the infrared camera of the bazooka type shooting device 28 is stopped, thereby to end the return processing.

In addition, as for colors of the slope 840, since it is the same as those of the slope 740 described above, a duplicate description is omitted.

When the return processing of the shooting device is started, the infrared camera of the shooting device currently used in the shooting game is stopped, and is activated in the return mode. In the return mode, a frame rate of the infrared camera is set to be lower than a frame rate in a case of the game mode that the shooting game is played.

This is because that it is only determined whether the shooting device is placed on the storage base 70 or the storage base 80 in the return mode and it is not necessary to make a frame rate high. Therefore, it is possible to reduce the processing load at the time of return.

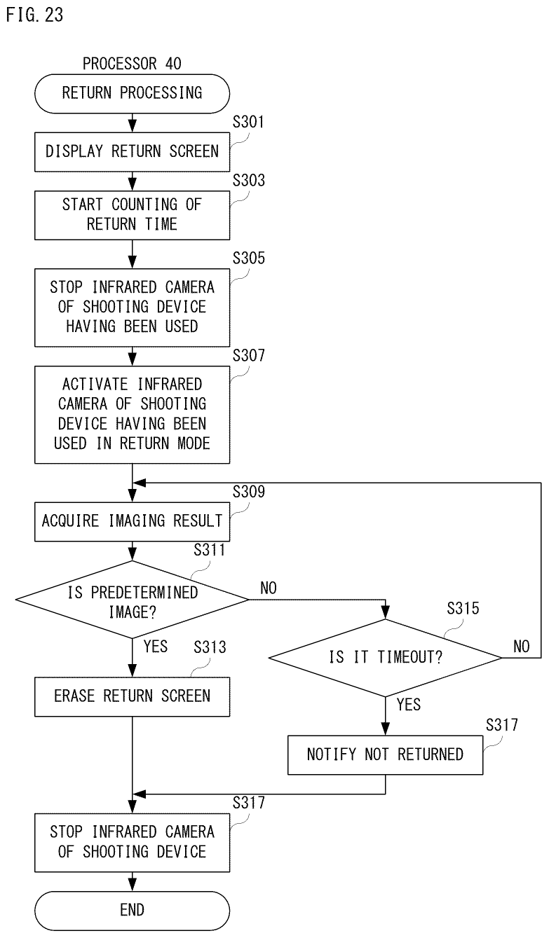

Specifically, the processor 40 of the game control PC 12 executes the return processing shown in FIG. 23. However, the return processing is individually and parallelly executed for each booth (or each gun PC 24). When ending the overall processing, the processor 40 starts the return processing, and shown in FIG. 23, displays a return screen on the front screen Sc in a step S301, and starts counting a return time in a step S303.

In a subsequent step S305, the infrared camera of the shooting device having been used in the shooting game is stopped. Here, the processor 40 instructs to the gun PC 24 to stop the infrared camera of the shooting device in use or under selection.

In a next step S307, the infrared camera of the shooting device having been used in the shooting game is activated in the return mode. Here, the processor 40 instructs to the gun PC 24 to activate the infrared camera having been stopped in the step S305.

Subsequently, an imaging result is acquired from the gun PC 24 (i.e., image processing PC 24a) in a step S309, and it is determined, in a step S311, whether the acquired imaging result shows a predetermined image. In addition, it is determined by the image processing PC 24a whether the predetermined image, i.e., an image having a lower portion in black and an upper portion in white is imaged, and such a determination result, i.e., whether the imaging result is the predetermined image is transmitted from the image processing PC 24a to the game control PC 12.

If “YES” is determined in the step S311, that is, if it is indicated that the acquired imaging result shows the predetermined image, the return screen is eliminated in a step S313, and the infrared camera of the shooting device is stopped in a step S317, thereby to end the return processing.

On the other hand, if “NO” is determined in the step S311, it is determined, in a step S315, whether it is a timeout. That is, the processor 40 determines whether the return time exceeds the time limit.

If “NO” is determined in the step S315, that is, if it is not a timeout, the process returns to the step S309. On the other hand, if “YES” is determined in the step S315, that is, if it is a timeout, it is notified a non-return in a step S317, and the process proceeds to a step S319.

In the step S319, the processor 40 displays a message that the shooting device has not been returned in the return screen. However, a non-return may be notified by displaying a further screen other than the return screen. Therefore, staff etc. of the entertainment facility AF can return the shooting device.

As similar to the first embodiment, in also the third embodiment, even if the plurality of players play the shooting game simultaneously, shooting of each player is correctly distinguishable.

Moreover, in the third embodiment, since the return processing is also executed, it is possible to determine whether the player has returned the shooting device to its original position.

In addition, the structure of the shooting game system, various kinds of screens and specific numeral values in the above-described embodiments are just examples, and should not be limited, and are modifiable suitably according to actual products.

Although certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

1. A shooting game system, comprising:
a screen that is provided upright on a floor surface to be displayed with an image;
a plurality of markers that are arranged side by side on the floor surface;
a plurality of shooting devices each provided with a camera that images the marker, the camera being set in a direction different from a shooting direction of the shooting device; and
one or more processors, wherein
the one or more processors calculates, for each of the plurality of shooting devices and based on an image of the marker that is imaged by the camera, coordinates in a virtual space corresponding to an intersection point between the shooting direction of the shooting device corresponding to a position and a direction of the camera and the screen, and makes the shooting game be executed using operation inputs of respective shooting devices and the coordinates of the virtual space.

2. The shooting game system according to claim 1, further comprising a setting place that the shooting device is set, wherein the plurality of markers are located between the screen and the setting place.

3. The shooting game system according to claim 1, wherein the shooting device comprises a barrel portion, and the camera is arranged inside a tip end of the barrel portion, facing diagonally downward from the shooting device.

4. The shooting game system according to claim 3, wherein the barrel portion has a shape that an upper side is projected ahead compared with a lower side, in the tip end of the barrel portion.

5. The shooting game system according to claim 1, further comprising a plurality of light emitting devices that are arranged above the markers and emit light toward the markers, wherein the markers reflect the light emitted from the light emitting devices.

6. The shooting game system according to claim 1, wherein the one or more processors selectively sets, based on an image that is imaged by the camera, a shooting device selectin mode that allows the player to select one shooting device from a plurality of types of shooting devices that the cameras are being activated and a shooting game mode that allows the player to perform the shooting game in a state where the camera of the a selected shooting device is being activated, and lowers a frame rate of the camera in the shooting device selection mode than a frame rate of the camera in the shooting game mode.

7. The shooting game system according to claim 6, wherein after an end of the shooting game mode, the one or more processors sets, based on the image that is imaged by the camera, a shooting device return mode that it is determined whether the shooting device is placed to a predetermined position in a state where the camera of the selected shooting device is being activated, and lowers a frame rate of the camera at a time of the shooting device return mode than the frame rate of the camera at the time of the shooting game mode.

8. The shooting game system according to claim 6, wherein the one or more processors displays on the screen, based on an image of the markers that is imaged by the camera, an image that allows the player to select one shooting device when the plurality of shooting devices are turned to the screen in the shooting device selection mode.

9. The shooting game system according to claim 5, wherein the light emitted from the light emitting device is an infrared light, and the marker includes a plate-like substrate that is arranged on the floor surface and reflects the infrared light, a first layer that is formed on the substrate and transmits the infrared light, a second layer that is formed on the substrate to be adjacent to the first layer and absorbs the infrared light, and a third layer that is formed on the first layer and the second layer and transmits the infrared light.

10. The shooting game system according to claim 9, wherein the first layer and the second layer of the marker are formed same or almost same height.

11. The shooting game system according to claim 1, further comprising a projector that projects an image on the screen, and the screen is arranged in a curved shape in a longitudinal direction.

12. An entertainment facility provided with the shooting game system according to claim 1.
